(19) United States
(12) Patent Application Publication
(10) Pub. No.: US 2018/0096556 A1
(43) Pub. Date: Apr. 5, 2018

(54) GAMING APPARATUS WITH AN AUTONOMOUS VALUE METER

(71) Applicant: Weike (S) Pte Ltd, Singapore (SG)

(72) Inventors: Po Lian Poh, Singapore (SG); Lay Ngee Tay, Singapore (SG)

(21) Appl. No.: 15/724,429

(22) Filed: Oct. 4, 2017

(30) Foreign Application Priority Data
Oct. 5, 2016 (SG) 10201608359S

(51) Int. Cl. G07F 17/32; G07F 17/34; H04L 29/08

(52) U.S. Cl. CPC G07F 17/326; G07F 17/34; H04L 67/02; G07F 17/3244; G07F 17/329

(57) ABSTRACT

Disclosed is a gaming apparatus, the gaming apparatus comprises a display member configured to visually display both a player result value meter and a separate autonomous value meter; a player input module arranged to accept a player input to play a turn of a game; a random number generator arranged for output of a game output result; a processing module configured to award a win value associated with the game output result, the processing module further configured to accumulate a portion of the win value into the player result value meter, the separate autonomous value meter or both; and wherein the processing module is configured to allow the player result value meter and the separate autonomous value meter to each be capable of being utilised to provide a next input to play a next turn of the game.

### TECHNICAL FIELD

The present disclosure relates broadly to a gaming apparatus.

### BACKGROUND

For current gaming machines and apparati, the inventors have recognised that players are using smaller inputs to play games. In addition, with increasing difficulties in games, the inventors have recognised a new problem that players increasingly end playing games relatively fast or early in the games.

The above problems typically cause players to miss out on viewing or playing additional feature or bonus games coupled to the main games. The above problems also typically cause players to have reduced levels of entertainment and enjoyment of the games.

In view of the above, there exists a need for a gaming apparatus that seeks to address at least one of the above problems.

### SUMMARY

In accordance with an aspect of the present disclosure, there is provided a gaming apparatus, the gaming apparatus comprising a display member configured to visually display both a player result value meter and a separate autonomous value meter; a player input module arranged to accept a player input to play a turn of a game; a random number generator arranged for output of a game output result; a processing module configured to award a win value associated with the game output result, the processing module further configured to accumulate a portion of the win value into the player result value meter, the separate autonomous value meter or both; and wherein the processing module is configured to allow the player result value meter and the separate autonomous value meter to each be capable of being utilised to provide a next input to play a next turn of the game.

The processing module may be further configured to accumulate the portion of the win value into the player result value meter, the separate autonomous value meter or both, based on one or more accumulation conditions.

The gaming apparatus may further comprise the processing module being configured to accumulate a portion of the win value into the player result value meter, the separate autonomous value meter or both, based on a comparison performed by the processing module of the win value against a pre-determined value threshold.

The gaming apparatus may further comprise the processing module being configured to accumulate a portion of the win value into the player result value meter, the separate autonomous value meter or both, based on a comparison performed by the processing module of the game output result against one or more accumulation rules pertaining to the game output result.

The gaming apparatus may further comprise the processing module being configured to automatically select one of the player result value meter and the separate autonomous value meter as a selected meter to provide the next input to play the next turn of the game, and wherein if an accumulated value within the selected meter is not sufficient to provide the next input, the processing module is configured to deduct the accumulated value within the selected meter and to deduct an outstanding amount of the next input from a non-selected meter.

The gaming apparatus may further comprise the player input module being configured to accept a player instruction to instruct the processing module to select one of the player result value meter and the separate autonomous value meter as a selected meter to provide the next input to play the next turn of the game, and wherein if an accumulated value within the selected meter is not sufficient to provide the next input, the processing module is configured to reduce a value of the next input to less than or equal to the accumulated value within the selected meter such that the next input is deducted from the accumulated value within the selected meter.

The gaming apparatus may further comprise the player input module being configured to accept a player instruction to instruct the processing module to select one of the player result value meter and the separate autonomous value meter as a selected meter to provide the next input to play the next turn of the game, and wherein if an accumulated value within the selected meter is not sufficient to provide the next input, the processing module is configured to terminate play of the game.

The gaming apparatus may further comprise the processing module being configured to only return a final accumulated value of the player result value meter to a player account upon receiving an instruction that play is to be terminated at the gaming apparatus.

The gaming apparatus may further comprise the display member configured to visually display a win meter, the win meter being configured to function as an intermediate meter to accumulate a portion of the win value which is to be accumulated into the player result value meter.

### BRIEF DESCRIPTION OF THE DRAWINGS

Example embodiments of the invention will be better understood and readily apparent to one of ordinary skill in the art from the following written description, by way of example only, and in conjunction with the drawings, in which:

FIG. 1A is a schematic front view diagram of a front panel of a gaming apparatus/machine in an example embodiment.

FIG. 1B is a schematic front view diagram of the gaming apparatus/machine with the front panel opened in part from the gaming machine in the example embodiment.

FIG. 2 is a schematic block diagram illustrating a gaming machine/apparatus in an example embodiment.

FIG. 3 is a schematic drawing illustrating a screenshot of an example main game output result in an example embodiment.

FIGS. 4A to 4C are schematic flowcharts for illustrating different gaming processes in different example embodiments where a processing module deducts an input from an autonomous value meter to play a turn of a game.

FIGS. 5A to 5C are schematic flowcharts for illustrating different gaming processes in different example embodiments where a processing module deducts an input from a player result value meter to play a turn of a game.

FIGS. 6A to 6C are schematic flowcharts for illustrating different gaming processes in different example embodiments where a player is allowed to select a player result value meter to play a turn of a game.

FIGS. 7A to 7C are schematic flowcharts for illustrating different gaming processes in different example embodiments where a player is allowed to select an autonomous value meter to play a turn of a game.

FIG. 7D is a schematic flowchart for illustrating a gaming process in an example embodiment where a player is allowed to select an autonomous value meter to enter a Free Play mode.

FIG. 8 is a schematic flowchart for illustrating a process of accumulation of a portion of a win value between different value meters and changing the state of a gaming apparatus in an example embodiment.

FIG. 9 is a schematic diagram illustrating a plurality of gaming apparati in a network in an example embodiment.

FIG. 10 shows a schematic drawing of a game system according to an example embodiment.

FIG. 11 is a schematic drawing of a computer system suitable for implementing an example embodiment.

FIG. 12 is a schematic drawing of a wireless communication device suitable for implementing an example embodiment.

### DETAILED DESCRIPTION

In an example embodiment, a gaming apparatus may be provided that changes its state based on its processing module being configured to accumulate a portion of a win value associated with a game output result into a player result value meter, a separate autonomous value meter or both. This accumulation may be based on one or more accumulation conditions. The processing module is also configured to allow the player result value meter and the separate autonomous value meter to each be capable of being utilised to provide a next input to play a next turn of the game.

For example, the one or more accumulation conditions may be comparing the win value against one or more win value thresholds. As another example, the one or more accumulation conditions may be comparing the game output result against one or more accumulation rules pertaining to the game output result itself.

Thus, the changing of the state of the gaming apparatus is not merely an accumulation of a win value into a conventional player result value meter. The changing of the state of the gaming apparatus is effected by the creation and maintenance of the autonomous value meter that is separate from the player result value meter. The autonomous value meter is autonomous from the player such that creation of the autonomous value meter is automatic by the processing module and accumulation of a value into the autonomous value meter is instructed by the processing module.

In the example embodiment, if the player elects to end playing at the gaming apparatus, the processing module is configured to allow only the player result value meter to return the accumulated value in the player result value meter to a player account. That is, the processing module is configured to only return a final accumulated value of the player result value meter to a player account upon receiving an instruction that play is to be terminated at the gaming apparatus.

In example embodiments herein, a RNG (Random Number Generator) may be used for RNG processes. A RNG may provide randomly generated numbers from which, for example, the outcomes of games are based upon. For example, the randomly generated numbers may be matched to a list of pre-determined numbers to determine whether the randomly generated numbers are a match. For example, if there is a match, a successful outcome is provided. The RNG is preferably independent of external factors. The RNG may generate random numbers without any input or preferably, with a preceding/previous random number as an input to generate a subsequent random number.

In an example implementation, the RNG may be in the form of a crystal oscillator that instructs a number generator processor to periodically generate new random numbers. If there is a seed (or preceding/previous random number) available, the number generator may use that seed as an input for the number generation.

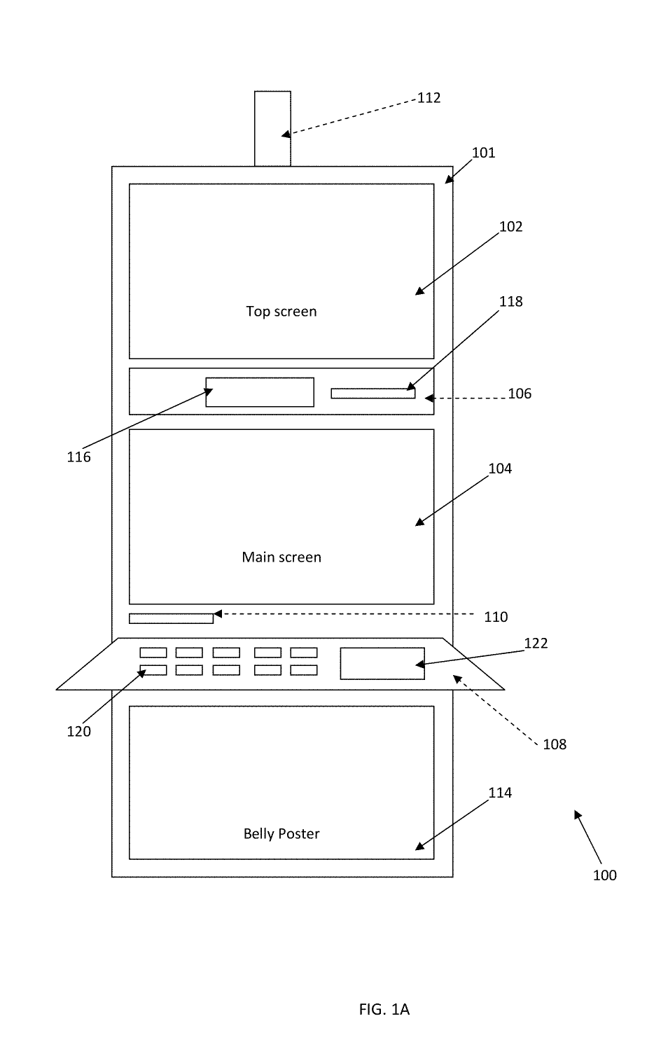

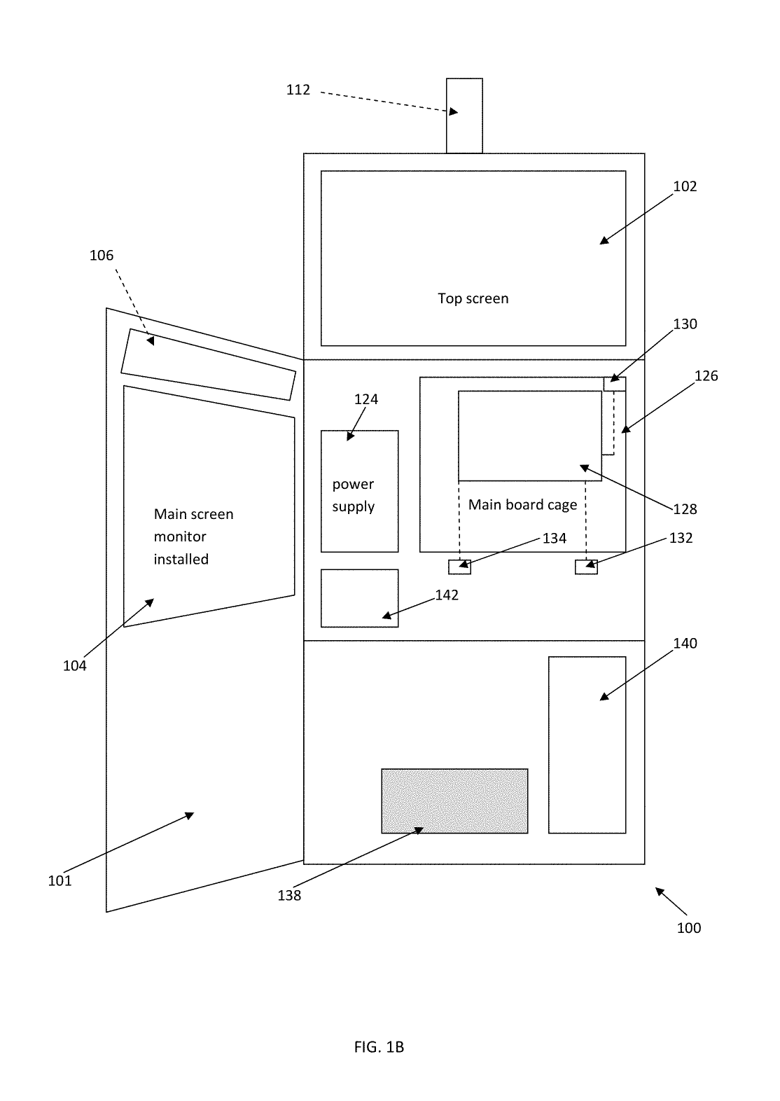

FIG. 1A is a schematic front view diagram of a front panel of a gaming apparatus/machine in an example embodiment. The gaming machine 100 comprises a front panel 101 that in turn comprises a top screen 102, a main screen 104, a player transactions panel 106 and a player interaction panel 108. The gaming machine 100 may optionally comprise a printer outlet 110, a tower light 112 and a poster display portion 114. The gaming machine 100 allows a player to play one or more games installed or network-implemented by the gaming machine 100.

In the example embodiment, the top screen 102 may be used to display game celebrations, promotional/advertising information or other information that is typically not primarily related to progression of the games of the gaming machine. The main screen 104 is used to display the games of the gaming machine 100, for the player's attention. Typically, the main screen 104 is the screen that the player focuses on for playing the games.

In the example embodiment, the player transactions panel 106 is provided for the player to transact with the gaming machine 100. The term “transactions” is taken to mean extraction of remaining points that the player possesses or insertion of points that the player possesses, for example, in a magnetic identification card or a radio frequency identification (RFID) card or any stored-value card. The term should not be limited to monetary transactions. The player transactions panel 106 comprises a liquid crystal display (LCD) information screen 116 and a card insert slot 118. The card insert slot 118 is used for receiving, in the case of a card insert slot, an identification card containing the points and/or identification belonging to the player. The points may be extracted from the card into the gaming machine 100 for playing the games installed in the gaming machine 100. Upon the player deciding to end play at the gaming machine 100, the player transactions panel 106 may store the latest/updated points information in the stored-value card. For example embodiments relating to using player identification cards, the player transactions panel 106 may retrieve points information of the player from an external server or database based on player identification. The retrieved information may then be used at the gaming machine 100 for playing the games. For such embodiments, upon the player deciding to end play at the gaming machine 100, the player transactions panel 106 may transmit the latest/updated points information to be stored on the external server or database based on the player identification. It will be appreciated that the card insert slot 118 may be in other forms depending on the type of identification card used by the player. For example, if the player is using a RFID card, the transactions module 118 may be a RFID reader/writer. The LCD information screen 116 is used to display e.g. the points information contained in the card.

The player interaction panel 108 comprises push buttons e.g. 120 provided to allow the player to actuate the buttons e.g. 120 for interacting with the games being played on the gaming machine 100. For example, the player may use the buttons e.g. 120 to make player selections being displayed on the main screen 104. For example, the player may use the buttons e.g. 120 to make a player input. In an alternative embodiment, the push buttons e.g. 120 may be replaced by a touch-sensitive screen that corresponds to the display on the main screen 104 to allow the player to interact with the games using touch commands. This may be in the form of a touch sensitive membrane with switch panels each corresponding to a display position of a display on the main screen 104.

A bill validator 122 may be provided for a player to use paper money to buy points for playing the games of the gaming machine 100. This is similar to, for example, using paper money at a vending machine to buy drinks/food.

It will be appreciated that although a card-in (using the card insert slot 118) and bill-in (using the bill validator 122) has been discussed above, the gaming machine is not limited as such and may comprise mechanisms to allow coin-in, key-in, ticket-in etc. for playing the games in the gaming machine.

It will be appreciated that the main screen 104 may be in the form of a touch-sensitive screen that may complement or replace the player interaction panel 108. The touch-sensitive screen may be a capacitive-type sensing screen, pressure-type sensing screen or the like. That is, the main screen 104 may be a touch-sensitive screen that allows the player to interact with the gaming machine 100 using touch commands. For example, the player may use touch commands to make a player input.

In the example embodiment, the printer outlet 110 may be provided for the gaming machine 100 to output information in printed form to the player. For example, the gaming machine 100 may print a sticker for the player. The gaming machine 100 may also print a receipt or record of the points transaction for the player. The tower light 112 may be provided to light up during game celebrations. This may attract the attention of spectators or the player. The tower light 112 may also be used for highlighting technical issues, requesting assistance or service etc. The poster display portion 114 may be provided for e.g. game information to be displayed.

In the example embodiment, the front panel 101 may be opened or detached in whole or in part from the gaming machine 100 body to allow, for example, maintenance on the circuits or components encased in the gaming machine 100.

FIG. 1B is a schematic front view diagram of the gaming apparatus/machine with the front panel opened in part from the gaming machine in the example embodiment. As shown, the front panel 101 is opened from the gaming machine 100, and opened in part containing the main screen 104 and the player transactions panel 106, to reveal the internal portion of the gaming machine 100.

The gaming machine 100 comprises a power supply unit 124 for powering the various components of the gaming machine 200. The power supply unit 124 is coupled to a main board circuits cage 126. The main board circuits cage 126 is used to contain and protect a game processing module 128. The game processing module 128 implements the games on the gaming machine and also implements game functions such as points/awards calculations. The game processing module 128 also drives visual contents, for example of the games, on the main screen 104 and, for example, audio content from the gaming machine 100. Speakers (not shown) are provided to output audio. Thus, the game processing module 128 may be a processor or a processing module/unit of the gaming machine 100.

In the example embodiment, the game processing module 128 is coupled to a random number generator 130 and a storage device 132. In an alternative example embodiment, the storage device 132 may be external to the gaming machine 100. In such an instance, the connection between the game processing module 128 and the storage device 132 may be by wired and/or wireless connections.

In the example embodiment, the storage device 132 is arranged to store one or more pre-determined value thresholds and/or one or more accumulation rules and/or one or more accumulation conditions. Each of the pre-determined value thresholds and/or one or more accumulation rules and/or one or more accumulation conditions is associated with an instruction set for instructing the game processing module 128 to perform a further action, for changing the state of the gaming machine 100.

In addition, the game processing module 128 is coupled to a player input module 134. The player input module 134 is coupled to one or more input actuators or members such as buttons e.g. 120 of a player interaction panel 108, or a touch screen input member of the main screen 104 etc.

The modules 128, 130, 132, 134 may be in the form of printed circuit boards comprising application-specific integrated circuits (ASIC) that may perform specific functions with inputs from components coupled to these modules.

In the example embodiment, the game processing module 128 facilitates implementation of one or more main/side games of the gaming machine 100 and facilitates the display of the one or more games on a display means/member of the gaming machine 100 such as the main screen 104. The game processing module 128 is configured to generate/operate a game display area showing the game in play. The generation/operation may be graphical such as a game display area generated/operated based on computer code or may be mechanical such as controlling mechanically rotatable reels, depending on implementation.

In the example embodiment, the player input module 134 is arranged to accept a player input for a game of the gaming machine 100. For example, the player input may be a player points input for playing a game. Thus, when the player input is a player points input, there is a value being input by the player, termed as player input value. Upon receipt of the player input, the game processing module 128 is arranged to instruct the random number generator 130 to perform various functions, such as obtaining/outputting a game output result. If the game output result is a win for the player, a points win amount is an example of a win value associated with a game output result for the player. It may also be provided that the value is not from a win of the game. In such an instance, even without a win of the game i.e. from the game output result, some points are still resultant from the game output result and awarded to the player as the win value associated with the game output result.

In the example embodiment, the game processing module 128 is arranged to accumulate a portion of the win value into a player result value meter, a separate autonomous value meter or both. The player result value meter and the separate autonomous value meter may be stored as databases in the storage device 132.

In the example embodiment, the game processing module 128 is arranged to allow the player result value meter and the separate autonomous value meter to each be capable of being utilised to provide a next input to play a next turn of the game.

In the example embodiment, the game processing module 128 is arranged to accumulate a portion of the win value into the player result value meter, the separate autonomous value meter or both based on a comparison processing using one or more accumulation conditions for changing the state of the gaming machine 100. For example, the accumulation may be based on a comparison performed by the processing module 128 of the win value against a pre-determined value threshold, the pre-determined value threshold being retrievable from the storage device 132. As another example, the accumulation may be based on a comparison performed by the processing module 128 of the game output result against one or more accumulation rules pertaining to the game output result, the one or more accumulation rules being retrievable from the storage device 132.

In the example embodiment, the comparison against the pre-determined value threshold and the comparison against one or more accumulation rules pertaining to the game output result may each be an accumulation condition.

The accumulation of the win value changes the state of the gaming machine 100 as there are a plurality of meters, the player result value meter and the separate autonomous value meter, to provide a next input to be selected to play a next turn of the game. In the example embodiment, such selection, between the player result value meter and the separate autonomous value meter to be utilised to provide the next input to be selected to play the next turn of the game, may be automatic by the game processing module 128 or by a player instruction received at the game processing module 128. In the example embodiment, the player input module 134 is further arranged to accept a player instruction to instruct the game processing module 128 to select one of the player result value meter and the separate autonomous value meter as a selected meter to provide the next input to play the next turn of the game.

The gaming machine 100 may optionally further comprise an interface circuit board 138 coupled to the game module 128, and a bill validator module 140 coupled to the game module 128. The bill validator module 140 comprises circuitry for implementing bill validation and counting. In the example embodiment, if a printer outlet 110 is provided, a printer 142 is also comprised in the gaming machine 100 for performing the printing functions.

It will be appreciated that the gaming machine 100 may further comprise other components that are not described here for clarity of illustration of the example embodiments.

The interface circuit board 138 may be optionally provided to communicate with a game control server (not shown) that may e.g. monitor the results of the games of the gaming machine 100, for example for logging results of main and/or side games of the gaming machine 100.

In such an example embodiment, a main or side game win that is awarded may trigger the game module 128 to instruct or inform the interface circuit board 138 that a favourable result has been obtained. The game control server may be informed via the interface circuit board 138.

In some example embodiments, the game control server (not shown) may e.g. communicate with the gaming machine 100, for example for informing of a winning instance of pool prize corresponding to a multiplied game win at the gaming machine 100. The communication with the game control server may be over a wired or wireless network.

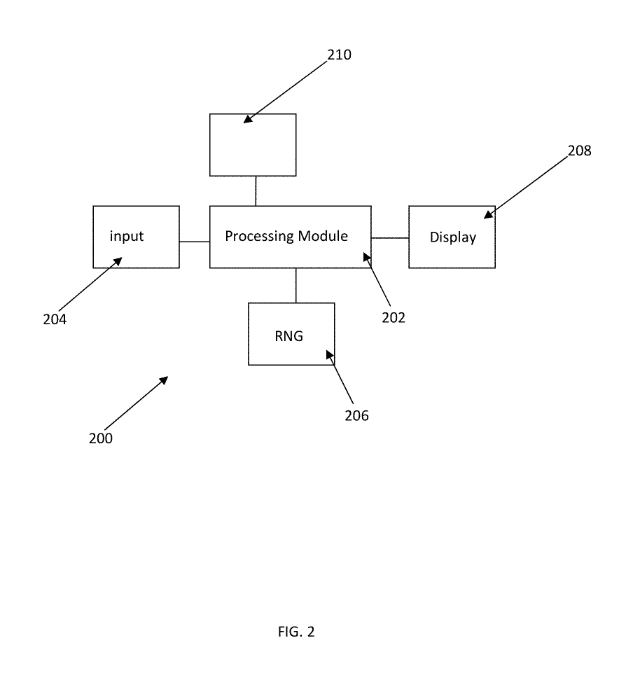

FIG. 2 is a schematic block diagram illustrating a gaming machine/apparatus in an example embodiment. The gaming apparatus 200 comprises a game processing module 202. The processing module 202 is coupled to a player input module 204 for accepting a player input to play a turn of a game implemented on the gaming apparatus 200. The processing module 202 is further coupled to a random number generator 206 and a display member 208. The processing module 202 is arranged to instruct the random number generator 206 to generate one or more random numbers. The processing module 202 is arranged to instruct the display member 208 to visually display both a player result value meter and a separate autonomous value meter.

In the example embodiment, the autonomous value meter is separate from the player result value meter and is autonomous from a player such that creation of the autonomous value meter is automatic by the processing module 202 and accumulation of a value into the autonomous value meter is instructed by the processing module 202.

In the example embodiment, the processing module 202 is arranged to provide a game output result based on the one or more random numbers generated by the random number generator 206. In some examples, the game output result may be the final symbols and/or positions of a reel game.

In the example embodiment, the processing module 202 is capable of awarding to the player a win value associated with the game output result. The win value may be the total points awarded or total win amount for a game output result. For example, for a reel game, the total points awarded may be the total points that is a summation of all possible winning combinations. The processing module 202 is further configured to accumulate a portion of the win value into the player result value meter, the separate autonomous value meter, or both. It will be appreciated that the portion of the win value may be a partial portion or a full portion of the win value. The final values accumulated in both the player result value meter and the separate autonomous value meter are visually displayed to the player. In some example embodiments, the portion of the win value may be accumulated into a win meter intermediate to eventual accumulation into the player result value meter. Thus, in such example embodiments, the accumulation of the portion of the win value may be termed interchangeably between the win meter or the player result value meter.

For example, the accumulation by the processing module of a portion of the win value into the player result value meter, the separate autonomous value meter or both may be based on a comparison performed by the processing module of the win value against a pre-determined value threshold. For example, a win value above a pre-determined value threshold may be accumulated in full by the processing module into the separate autonomous value meter while a win value below the pre-determined value threshold may be accumulated in full by the processing module into the player result value meter. Alternatively, a win value above a pre-determined value threshold may be accumulated in full by the processing module into the player result value meter while a win value below the pre-determined value threshold may be accumulated in full by the processing module into the separate autonomous value meter.

As yet another example, the accumulation by the processing module of a portion of the win value into the player result value meter, the separate autonomous value meter or both may be based on a comparison performed by the processing module of the game output result against one or more accumulation rules pertaining to the game output result.

For example, for an accumulation rule for a reel game, the points awarded for one or more pre-determined winning combinations may be accumulated by the processing module into the separate autonomous value meter while the points awarded for any other winning combinations may be accumulated by the processing module into the player result value meter.

As another example, for another accumulation rule for a reel game, the points awarded from one or more pre-determined multipliers may be accumulated by the processing module into the separate autonomous value meter while the points awarded for any other multipliers may be accumulated by the processing module into the player result value meter.

For example, for an accumulation rule for a reel game, the points awarded for one or more pre-determined winning combinations (either in a line or a scatter combination) with one or more pre-determined marking appearing on a symbol of the winning combinations may be accumulated by the processing module into the separate autonomous value meter while the points awarded for any other winning combinations without the one or more pre-determined marking appearing on a symbol of the winning combinations may be accumulated by the processing module into the player result value meter. Alternatively, the arrangement may be reversed such that the points awarded for one or more pre-determined winning combinations (either in a line or a scatter combination) with one or more pre-determined marking appearing on a symbol of the winning combinations may be accumulated by the processing module into the player result value meter while the points awarded for any other winning combinations without the one or more pre-determined marking appearing on a symbol of the winning combinations may be accumulated by the processing module into the separate autonomous value meter.

For another example, for an accumulation rule for a reel game, the points awarded for one or more pre-determined winning combinations, if one or more pre-determined marking appears on a symbol within the game output result, may be accumulated by the processing module into the separate autonomous value meter while the points awarded for any other winning combinations, if one or more pre-determined marking do not appear on a symbol within the game output result, may be accumulated by the processing module into the player result value meter. Alternatively, the arrangement may be reversed such that the points awarded for one or more pre-determined winning combinations, if one or more predetermined marking appears on a symbol within the game output result, may be accumulated by the processing module into the player result value meter while the points awarded for any other winning combinations, if one or more pre-determined marking do not appear on a symbol within the game output result, may be accumulated by the processing module into the separate autonomous value meter.

In the example embodiment, the comparison against the pre-determined value threshold and the comparison against one or more accumulation rules pertaining to the game output result may each be an accumulation condition.

In the example embodiment, the processing module 202 is coupled to a storage device 210. The storage device may store one or more pre-determined value thresholds and/or one or more accumulation rules and/or one or more accumulation conditions. The storage device may also store the player result value meter and the separate autonomous value meter as one or more databases. In some example embodiments, the storage device 210 may be external the gaming apparatus 200.

In the example embodiment, the processing module 202 is configured to allow the player result value meter and the separate autonomous value meter to each be capable of being utilised to provide a next input to play a next turn of the game.

For example, the processing module may be configured to automatically utilise one of the player result value meter and the separate autonomous value meter to provide the next input to play the next turn of the game. It may be provided that if the value of the selected meter, either the player result value meter or the separate autonomous value meter, is not sufficient to provide the player input, the processing module may be configured to deduct the available/remaining value from the selected meter and to deduct the outstanding input amount from the other non-selected meter.

As an alternative example, the player input module may be configured to accept a player instruction to instruct the processing module to utilise one of the player result value meter and the separate autonomous value meter to provide the next input to play the next turn of the game. For example, the player is allowed to select either the player result value meter or the separate autonomous value meter to deduct input points as an input to play the next turn of the game. It may be provided that if the value of the selected meter, either the player result value meter or the separate autonomous value meter, is not sufficient to provide the player input, the processing module may be configured to either reduce the next input to play the next turn of the game such that the next input can be deducted from the value of the selected meter or to end play of the game.

In the example embodiment, if the player elects to end playing at the gaming apparatus, the processing module is configured to allow only the player result value meter to return the accumulated value in the player result value meter to a player account. That is, the processing module is configured to only return a final accumulated value of the player result value meter to a player account upon receiving an instruction that play is to be terminated at the gaming apparatus. In other example embodiments whereby a Win meter is used intermediately to display an accumulated value before transferrance of the value to the player result value meter.

Therefore, in the example embodiment, the accumulated win value in the separate autonomous value meter may be seen as virtual points and points that may be used to play free turns of the game. Thus, in various example embodiments, the autonomous value meter may also be termed a free play meter.

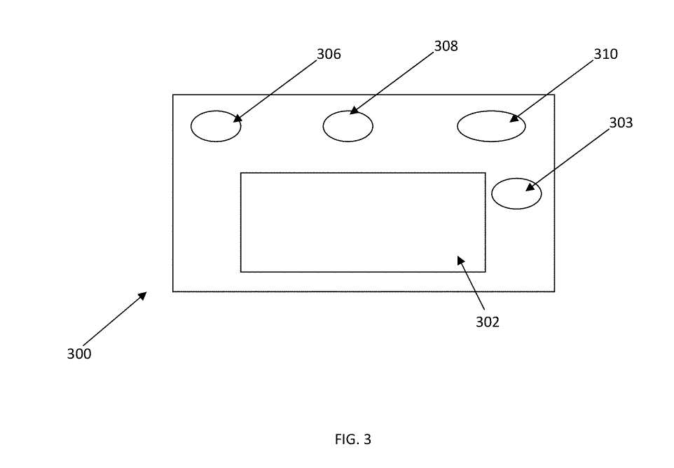

FIG. 3 is a schematic drawing illustrating a screenshot 300 of an example main game output result in an example embodiment. The main game may be implemented on a gaming machine substantially identical to the gaming machines 100, 200 respectively of FIGS. 1A, B and 2.

In the screenshot 300, the main game output result is displayed at a main game display portion 302. A main game output result value meter 303 is provided and visually displayed. The main game output result value meter 303 functions to display an amount of points or value awarded from the main game output result.

In the example embodiment, a player input is displayed at a player input display portion 306. The player may input an amount of points from the player's account to play the main game. The player input may be input via a player input module (compare e.g. player input module 134 of FIG. 1B).

A player result value meter 308 and a separate autonomous value meter 310 are visually displayed to the player via a display member (compare e.g. main screen 104 of FIG. 1A). The player result value meter 308 and the separate autonomous value meter 310 display respective values retrieved from respective databases. In some example embodiments, the main game output result value meter 303 functions as a win meter that is in turn configured to function as an intermediate meter to accumulate a portion of the win value which is to be accumulated into the player result value meter 308.

In one example, the player may have 200 available points. The player may activate the player input module to provide a player input of 1 point from the 200 available points to play a turn of the game. The player input of 1 point is displayed at the player input display portion 306.

A random number generator (not shown) is arranged to output a game output result as the main game output result. The main game output result is displayed at the main game display portion 302.

In the example, the processing module (not shown) of the gaming machine determines whether there is any win associated with the main game output result. The determination may be based on, but is not limited to, winning symbol combinations appearing in the main game output result. If the processing module determines that there is at least one win associated with the main game output result, the processing module awards a win value associated with the main game output result. For example, the win value may be 10 points. The win value is displayed in the main game output result value meter 303.

In the example, the processing module of the gaming machine accumulates a portion of the win value into the player result value meter 308, the separate autonomous value meter 310 or both. For example, the processing module may accumulate 4 out of the 10 points into the player result value meter 308 and the remaining 6 out of the 10 points into the separate autonomous value meter 310. The accumulated values displayed in the player result value meter 308 and the separate autonomous value meter 310 are also stored in the respective databases associated with the player result value meter 308 and the separate autonomous value meter 310.

In the example, the processing module of the gaming machine allows the player result value meter 308 and the separate autonomous value meter 310 to each be capable of being utilised to provide a next input displayed at the player input display portion 306 to play a next turn of the game. For example, the separate autonomous value meter 310 displaying 6 points may be used to play 6 turns of the game at 1 point for each turn. Such utilisation of the player result value meter 308 and the separate autonomous value meter 310 to provide a next input displayed at the player input display portion 306 to play a next turn of the game may be automatic by the processing module or may be player-selectable. For example, the player may select the player result value meter 308 or the separate autonomous value meter 310 by touch screen commands on the visual display of the respective meter 308, 310 to select the chosen meter to provide a next input displayed at the player input display portion 306 to play a next turn of the game.

In the example, if the player elects to end playing at the gaming machine, the processing module, upon receiving an instruction that play is to be terminated at the gaming machine, is configured to allow only the player result value meter 308 to return the final accumulated value in the player result value meter 308 to the player account. The player account value may thereafter be synchronised to the player's account on a player's identification card or on an electronic database.

Therefore, in the example embodiment, the accumulated win value in the separate autonomous value meter 310 may be seen as virtual points and points that may be used to play free turns of the game.

In the example embodiment, the accumulation may be of any win type from a main game or a free game, such as, but not limited to, from a symbol combination win, and/or a symbol scatter win, and/or a multiplier win, and/or a mystery bonus win, and/or a player selection bonus win, and/or an in-machine jackpot win, a network jackpot win etc.

In one example, the processing module of the gaming machine accumulates a full portion of the win value into the player result value meter 308. Thus, no portion of the win value or no points are accumulated into the separate autonomous value meter 310.

In another example, the processing module of the gaming machine accumulates a full portion of the win value into the separate autonomous value meter 310. Thus, no portion of the win value or no points are accumulated into the player result value meter 308.

In another example, the processing module of the gaming machine accumulates a portion of the win value into both the player result value meter 308 and the separate autonomous value meter 310. Such accumulation is based on one or more accumulation conditions stored in a storage device of the gaming machine (compare e.g. storage device 132 of FIG. 1B).

Provided below are a number of non-limiting examples of the one or more accumulation conditions.

In one example, the accumulation condition is based on a pre-determined total win value threshold. Thus, the processing module accumulates a portion of the win value into the player result value meter, the separate autonomous value meter or both, based on a comparison performed by the processing module of the win value against a pre-determined value threshold.

For example, the pre-determined value threshold may be set at 500 points. If the win value associated with the main game output result is less than the threshold of 500 points, for example if the win value is 400 points, the processing module of the gaming machine accumulates all 400 points into the separate autonomous value meter. Conversely, if the win value associated with the main game output result is more than the threshold of 500 points, for example if the win value is 600 points, the processing module of the gaming machine accumulates all 600 points into the player result value meter.

Alternatively, the accumulation condition may be reversed. That is, if the win value associated with the main game output result is less than the threshold of 500 points, for example if the win value is 400 points, the processing module of the gaming machine accumulates all 400 points into the player result value meter. If the win value associated with the main game output result is more than the threshold of 500 points, for example if the win value is 600 points, the processing module of the gaming machine accumulates all 600 points into the separate autonomous value meter.

In another example, the accumulation condition is based on one or more accumulation rules pertaining to the game output result. Thus, the processing module accumulates a portion of the win value into the player result value meter, the separate autonomous value meter or both, based on a comparison performed by the processing module of the game output result against one or more accumulation rules pertaining to the game output result.

In an example of having one or more accumulation rules pertaining to the game output result, a plurality of accumulation rules may be associated with different pre-determined symbol combinations.

In such an example, there may be seven different symbols A, B, C, D, E, F, G. One accumulation rule may specify that symbol combinations from A, B, C, D resulting in win values instructs the processing module to accumulate such win values into the separate autonomous value meter, and another accumulation rule may specify that any other symbol combinations from E, F, G resulting in win values instructs the processing module to accumulate such win values into the player result value meter. In some examples, symbol combinations from A, B, C, D may be low winning symbols.

Therefore, in a game, if 3×A and 4×C symbols are obtained, the processing module accumulates the win value associated with 3×A and 4×C into the separate autonomous value meter. If 3×F and 4×G symbols are obtained, the processing module accumulates the win value associated with 3×F and 4×G into the player result value meter.

It may even be provided that if 3×A and 4×G symbols are obtained, the processing module accumulates a portion of the win value, i.e. the portion associated with 3×A, into the separate autonomous value meter, and the processing module accumulates the remaining portion of the win value, i.e. the portion associated with 4×G, into the player result value meter.

Alternatively, the accumulation condition may be reversed.

That is, one accumulation rule may specify that symbol combinations from A, B, C, D resulting in win values instructs the processing module to accumulate such win values into the player result value meter, and another accumulation rule may specify that any other symbol combinations from E, F, G resulting in win values instructs the processing module to accumulate such win values into the separate autonomous value meter.

In such a scenario, in a game, if 3×A and 4×C symbols are obtained, the processing module accumulates the win value associated with ×A and 4×C into the player result value meter. If 3×F and 4×G symbols are obtained, the processing module accumulates the win value associated with 3×F and 4×G into the separate autonomous value meter. Further, if 3×A and 4×G symbols are obtained, the processing module accumulates a portion of the win value, i.e. the portion associated with 3×A, into the player result value meter, and the processing module accumulates the remaining portion of the win value, i.e. the portion associated with 4×G, into the separate autonomous value meter.

In another example of having one or more accumulation rules pertaining to the game output result, a plurality of accumulation rules may be associated with different numbers of symbol appearances within the game output result.

One accumulation rule may specify that for a symbol A that appears between 1 or 3 times within the game output result, the rule instructs the processing module to accumulate a win value associated with such appearances into the separate autonomous value meter. Another accumulation rule may specify that if the symbol A that appears for more than 3 times, the rule instructs the processing module to accumulate a win value associated with such appearances into the player result value meter.

Therefore, in a game, if the symbol A appears for 1 time, or 2 times or 3 times, the processing module accumulates the win value associated with the number of appearances into the separate autonomous value meter. If the symbol A appears for 4 times or 5 times, the processing module accumulates the win value associated with the number of appearances into the player result value meter.

Alternatively, the accumulation condition may be reversed. That is, one accumulation rule may specify that for a symbol A that appears between 1 or 3 times within the game output result, the rule instructs the processing module to accumulate a win value associated with such appearances into the player result value meter. Another accumulation rule may specify that if the symbol A that appears for more than 3 times, the rule instructs the processing module to accumulate a win value associated with such appearances into the separate autonomous value meter.

In such a scenario, in a game, if the symbol A appears for 1 time, or 2 times or 3 times, the processing module accumulates the win value associated with the number of appearances into the player result value meter. If the symbol A appears for 4 times or 5times, the processing module accumulates the win value associated with the number of appearances into the separate autonomous value meter.

In yet another example of having one or more accumulation rules pertaining to the game output result, a plurality of accumulation rules may be associated with multiplier instances within the game output result.

One accumulation rule may specify that if a ×2 (or 2 times) multiplier or a ×3 (or 3 times) multiplier appears and multiplies a win value obtained from a game output result, the rule instructs the processing module to accumulate a win value associated with the multiplier into the separate autonomous value meter.

Another accumulation rule may specify that if a ×5 (or 5 times) multiplier or a ×10 (or 10 times) multiplier appears and multiplies a win value obtained from a game output result, the rule instructs the processing module to accumulate a win value associated with the multiplier into the player result value meter.

Alternatively, the accumulation condition may be reversed. That is, one accumulation rule may specify that if a ×2 (or 2 times) multiplier or a ×3 (or 3 times) multiplier appears and multiplies a win value obtained from a game output result, the rule instructs the processing module to accumulate a win value associated with the multiplier into the player result value meter. Another accumulation rule may specify that if a ×5 (or 5 times) multiplier or a ×10 (or 10 times) multiplier appears and multiplies a win value obtained from a game output result, the rule instructs the processing module to accumulate a win value associated with the multiplier into the separate autonomous value meter.

In yet another example of having one or more accumulation rules pertaining to the game output result, a plurality of accumulation rules may be associated with one or more pre-determined marking appearing on a symbol of one or more winning combinations within the game output result.

One accumulation rule may specify that if there is one or more winning combinations within the game output result, these winning combinations being, for example, from a line or scatter type win, and if there is one or more pre-determined marking appearing on a symbol of the one or more winning combinations, the rule instructs the processing module to accumulate a win value associated with such winning combinations into the player result value meter.

Another accumulation rule may specify that the win value, associated with other winning combinations that do not have the one or more pre-determined marking appearing on a symbol, be accumulated by the processing module into the separate autonomous value meter.

Alternatively, the accumulation condition may be reversed. That is, one accumulation rule may specify that if there is one or more winning combinations within the game output result, these winning combinations being, for example, from a line or scatter type win, and if there is one or more pre-determined marking appearing on a symbol of the one or more winning combinations, the rule instructs the processing module to accumulate a win value associated with such winning combinations into the separate autonomous value meter. Another accumulation rule may specify that the win value, associated with other winning combinations that do not have the one or more pre-determined marking appearing on a symbol, be accumulated by the processing module into the player result value meter.

In yet another example of having one or more accumulation rules pertaining to the game output result, a plurality of accumulation rules may be associated with one or more pre-determined marking appearing on a symbol of the game output result if there is one or more winning combinations within the game output result.

One accumulation rule may specify that if there is one or more winning combinations within the game output result, these winning combinations being, for example, from a line or scatter type win, and if there is one or more pre-determined marking appearing on a symbol within the game output result and not necessarily within the winning combinations, the rule instructs the processing module to accumulate a win value associated with the winning combinations into the player result value meter.

Another accumulation rule may specify that if there is one or more winning combinations within the game output result, these winning combinations being, for example, from a line or scatter type win, and if there is no pre-determined marking appearing on a symbol within the game output result, the rule instructs the processing module to accumulate a win value associated with the winning combinations into the separate autonomous value meter.

Alternatively, the accumulation condition may be reversed. That is, one accumulation rule may specify that if there is one or more winning combinations within the game output result, these winning combinations being, for example, from a line or scatter type win, and if there is one or more pre-determined marking appearing on a symbol within the game output result and not necessarily within the winning combinations, the rule instructs the processing module to accumulate a win value associated with the winning combinations into the separate autonomous value meter. Another accumulation rule may specify that if there is one or more winning combinations within the game output result, these winning combinations being, for example, from a line or scatter type win, and if there is no pre-determined marking appearing on a symbol within the game output result, the rule instructs the processing module to accumulate a win value associated with the winning combinations into the player result value meter.

Further, in the example embodiment, for providing an input to play a turn of the game, the processing module may instruct the input to be deducted from the player result value meter, with any outstanding value to be deducted from the separate autonomous value meter. Alternatively, the processing module may instruct the input to be deducted from the separate autonomous value meter, with any outstanding value to be deducted from the player result value meter.

As yet another alternative, the processing module may allow the player to select the separate autonomous value meter or the player result value meter as a selected meter to deduct the input to play a turn of the game. For example, the player may make the selection via a player input module such as using a touchscreen input or using an actuator such as a button. For example, the player may use the touchscreen to touch the separate autonomous value meter or the player result value meter to select the touched meter as a selected meter to deduct the input to play a turn of the game.

The processing module can be configured such that if an accumulated value within the selected meter is not sufficient to provide the next input, the processing module either reduces the next input to play the next turn of the game such that the next input can be deducted from the value of the selected meter or to end play of the game.

In the following description, other example embodiments are described.

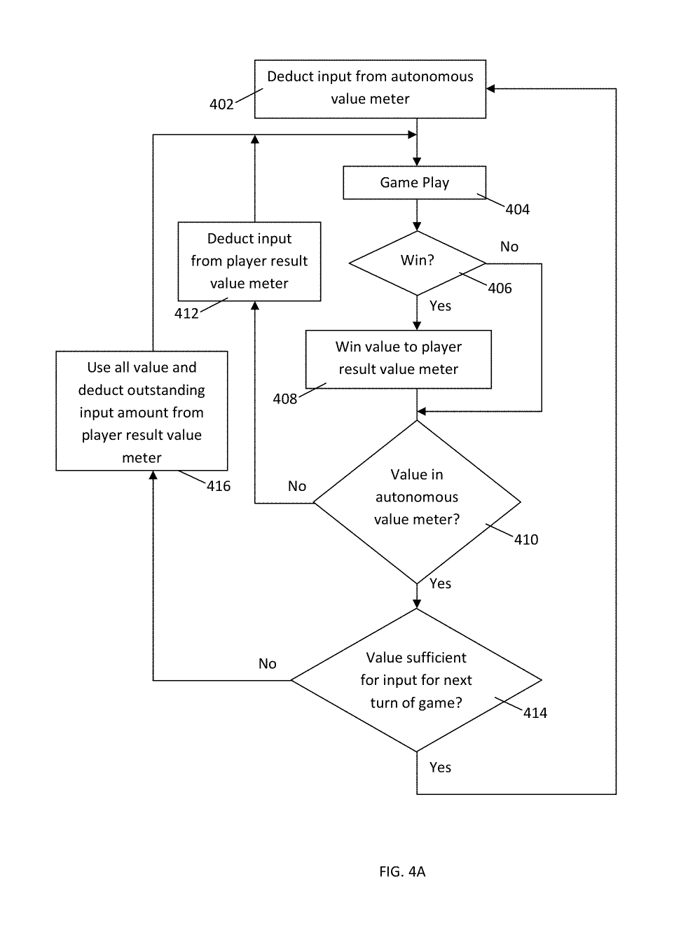

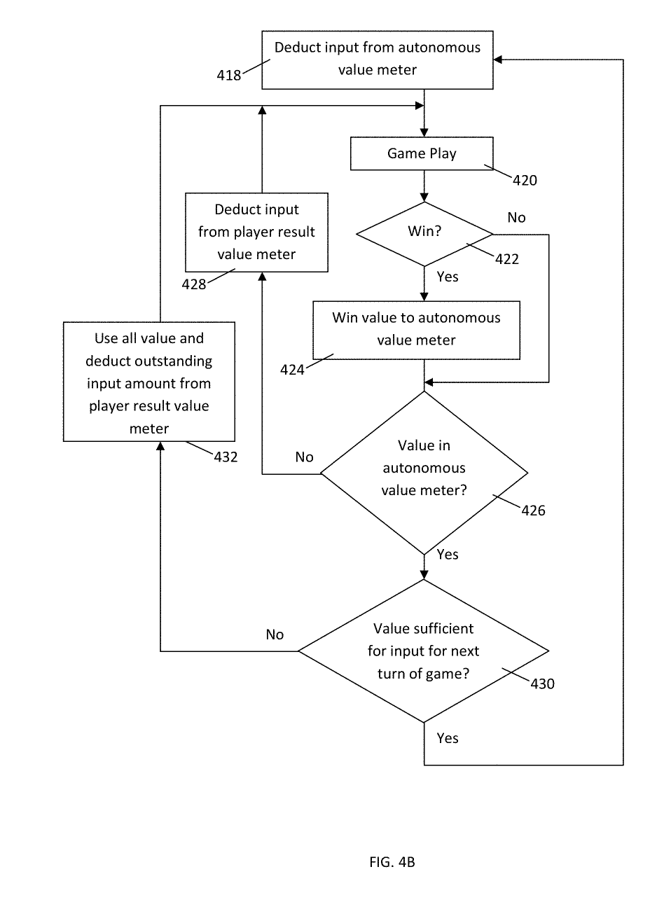

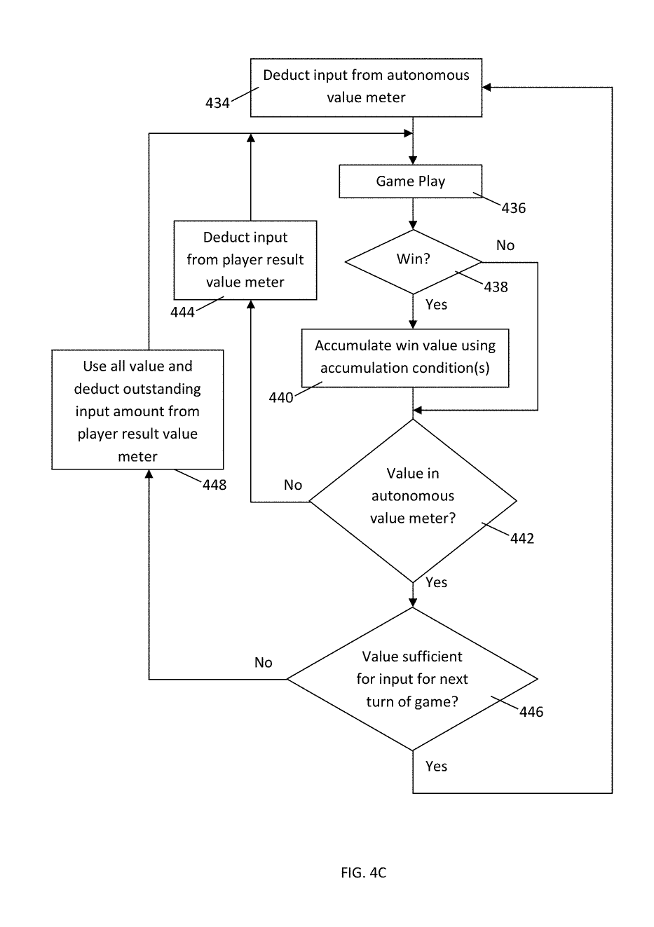

FIGS. 4A to 4C are schematic flowcharts for illustrating different gaming processes in different example embodiments where a processing module deducts an input from an autonomous value meter to play a turn of a game. The gaming processes are of a gaming apparatus that is substantially identical to the gaming apparatus 100, 200 as described in FIGS. 1A, 1B and 2.

In these example embodiments, a player input is deducted from an autonomous value meter to begin the gaming processes for playing a turn of a game. For the next turn of the game, a processing module of the gaming apparatus determines whether there is value remaining in the autonomous value meter to contribute as the player input for the next turn of the game.

With reference to FIG. 4A, at step 402, the processing module deducts a player input from the autonomous value meter to play a turn of the game. At step 404, the processing module instructs a random number generator for output of a game output result. At step 406, the processing module determines whether there is a win from the game output result. If there is no win, the process proceeds to step 410. Otherwise, if there is a win at step 406, at step 408, the processing module awards a win value associated with the game output result and the processing module accumulates the win value into a player result value meter.

At step 410, for a next turn of the game, the processing module determines whether there is any value remaining in the autonomous value meter to contribute as the player input for the next turn of the game. If there is no value remaining in the autonomous value meter, at step 412, the processing module deducts the player input from the player result value meter. Otherwise, if there is value remaining in the autonomous value meter at step 410, at step 414, the processing module determines whether the remaining value is sufficient for the player input for the next turn of the game. If the remaining value is sufficient, the process proceeds to step 402.

If the remaining value in the autonomous value meter is determined to be not sufficient at step 414, at step 416, the processing module deducts all value from the autonomous value meter and also deducts the outstanding input amount from the player result value meter before proceeding to the game play at step 404.

In the above gaming process, the processing module instructs the accumulation of the win value based on an accumulation condition which is to accumulate the win value into the player result value meter.

With reference to FIG. 4B, at step 418, the processing module deducts a player input from the autonomous value meter to play a turn of the game. At step 420, the processing module instructs a random number generator for output of a game output result. At step 422, the processing module determines whether there is a win from the game output result. If there is no win, the process proceeds to step 426. Otherwise, if there is a win at step 422, at step 424, the processing module awards a win value associated with the game output result and the processing module accumulates the win value into the autonomous value meter.

At step 426, for a next turn of the game, the processing module determines whether there is any value remaining in the autonomous value meter to contribute as the player input for the next turn of the game. If there is no value remaining in the autonomous value meter, at step 428, the processing module deducts the player input from the player result value meter. Otherwise, if there is value remaining in the autonomous value meter at step 426, at step 430, the processing module determines whether the remaining value is sufficient for the player input for the next turn of the game. If the remaining value is sufficient, the process proceeds to step 418.

If the remaining value in the autonomous value meter is determined to be not sufficient at step 430, at step 432, the processing module deducts all value from the autonomous value meter and also deducts the outstanding input amount from the player result value meter before proceeding to the game play at step 420.

In the above gaming process, the processing module instructs the accumulation of the win value based on an accumulation condition which is to accumulate the win value into the autonomous value meter.

With reference to FIG. 4C, at step 434, the processing module deducts a player input from the autonomous value meter to play a turn of the game. At step 436, the processing module instructs a random number generator for output of a game output result. At step 438, the processing module determines whether there is a win from the game output result. If there is no win, the process proceeds to step 442. Otherwise, if there is a win at step 438, at step 440, the processing module awards a win value associated with the game output result and the processing module accumulates the win value into the autonomous value meter, the player result value meter, or both, based on one or more accumulation conditions.

At step 442, for a next turn of the game, the processing module determines whether there is any value remaining in the autonomous value meter to contribute as the player input for the next turn of the game. If there is no value remaining in the autonomous value meter, at step 444, the processing module deducts the player input from the player result value meter. Otherwise, if there is value remaining in the autonomous value meter at step 442, at step 446, the processing module determines whether the remaining value is sufficient for the player input for the next turn of the game. If the remaining value is sufficient, the process proceeds to step 434.

If the remaining value in the autonomous value meter is determined to be not sufficient at step 446, at step 448, the processing module deducts all value from the autonomous value meter and also deducts the outstanding input amount from the player result value meter before proceeding to the game play at step 436.

In the above gaming process, the processing module instructs the accumulation of the win value based on one or more accumulation conditions. Such accumulation conditions may include, but are not limited to, comparison of the win value against one or more value thresholds, or comparison of the game output result against one or more accumulation rules pertaining to the game output result, etc.

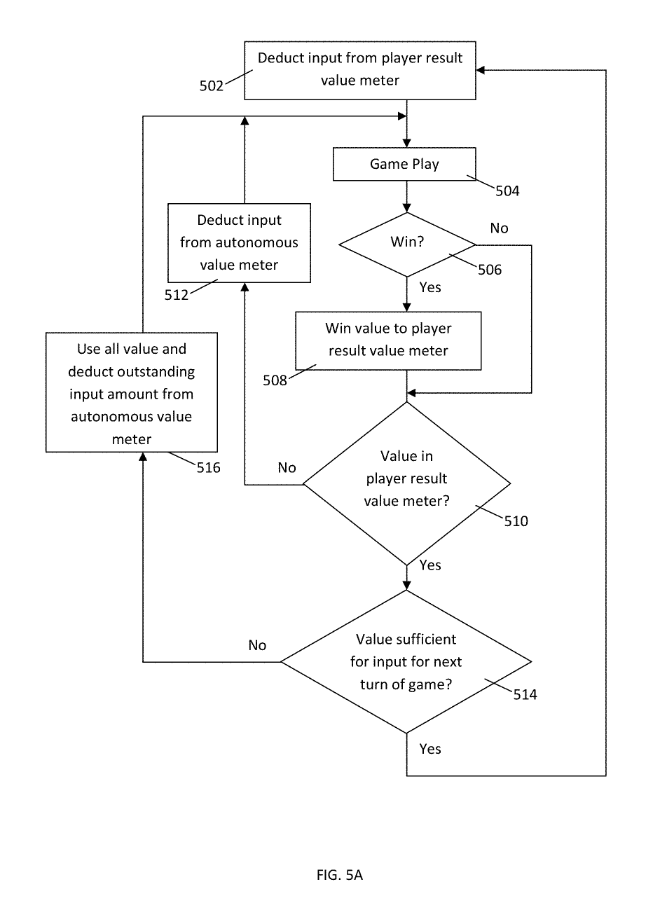

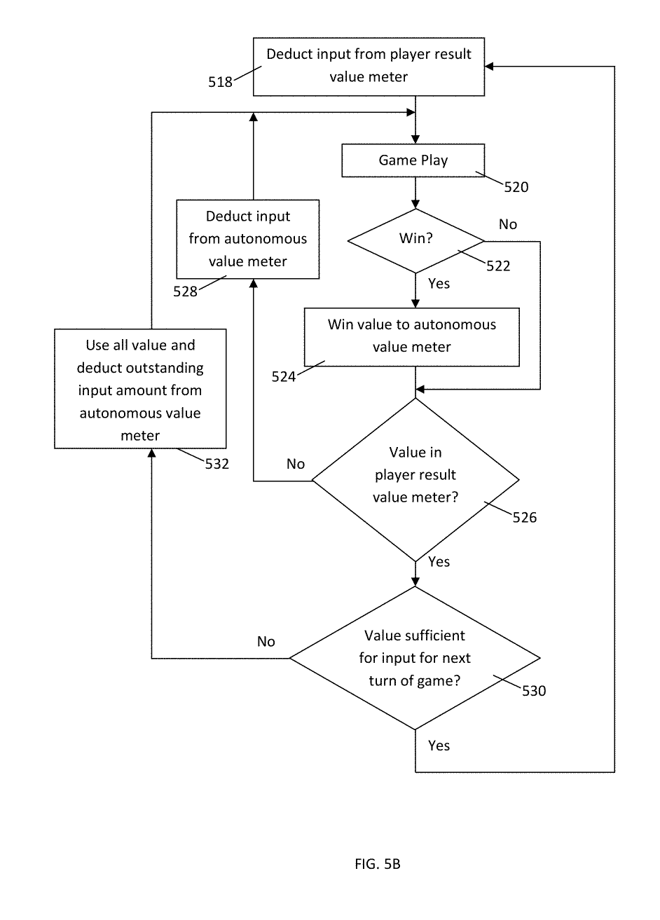

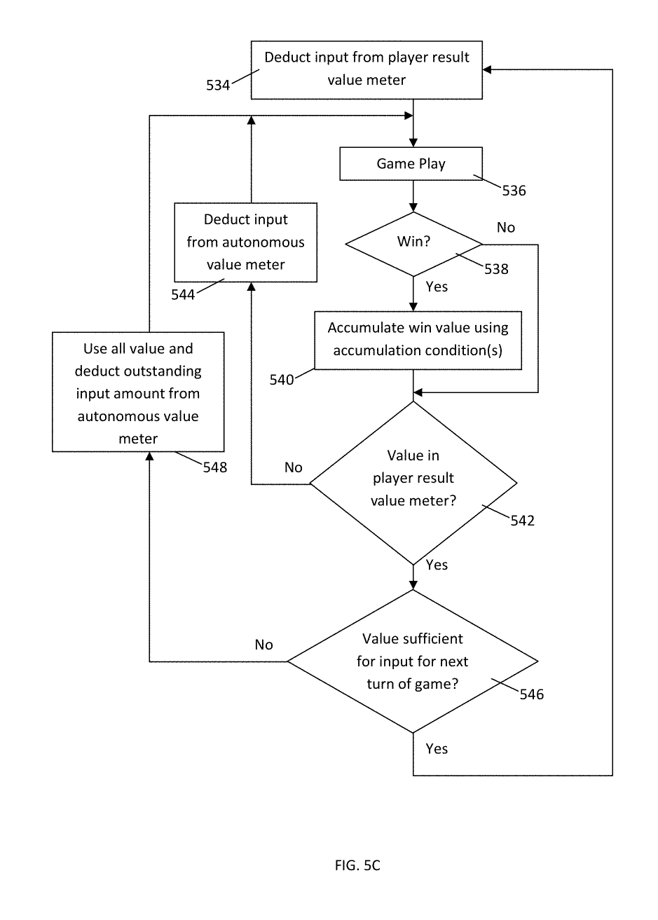

FIGS. 5A to 5C are schematic flowcharts for illustrating different gaming processes in different example embodiments where a processing module deducts an input from a player result value meter to play a turn of a game. The gaming processes are of a gaming apparatus that is substantially identical to the gaming apparatus 100, 200 as described in FIGS. 1A, 1B and 2.

In these example embodiments, a player input is deducted from a player result value meter to begin the gaming processes for playing a turn of a game. For the next turn of the game, a processing module of the gaming apparatus determines whether there is value remaining in the player result value meter to contribute as the player input for the next turn of the game.

With reference to FIG. 5A, at step 502, the processing module deducts a player input from the player result value meter to play a turn of the game. At step 504, the processing module instructs a random number generator for output of a game output result. At step 506, the processing module determines whether there is a win from the game output result. If there is no win, the process proceeds to step 510. Otherwise, if there is a win at step 506, at step 508, the processing module awards a win value associated with the game output result and the processing module accumulates the win value into the player result value meter.

At step 510, for a next turn of the game, the processing module determines whether there is any value remaining in the player result value meter to contribute as the player input for the next turn of the game. If there is no value remaining in the player result value meter, at step 512, the processing module deducts the player input from the autonomous value meter. Otherwise, if there is value remaining in the player result value meter at step 510, at step 514, the processing module determines whether the remaining value is sufficient for the player input for the next turn of the game. If the remaining value is sufficient, the process proceeds to step 502.

If the remaining value in the player result value meter is determined to be not sufficient at step 514, at step 516, the processing module deducts all value from the player result value meter and also deducts the outstanding input amount from the autonomous value meter before proceeding to the game play at step 504.

In the above gaming process, the processing module instructs the accumulation of the win value based on an accumulation condition which is to accumulate the win value into the player result value meter.

With reference to FIG. 5B, at step 518, the processing module deducts a player input from the player result value meter to play a turn of the game. At step 520, the processing module instructs a random number generator for output of a game output result. At step 522, the processing module determines whether there is a win from the game output result. If there is no win, the process proceeds to step 526. Otherwise, if there is a win at step 522, at step 524, the processing module awards a win value associated with the game output result and the processing module accumulates the win value into the autonomous value meter.

At step 526, for a next turn of the game, the processing module determines whether there is any value remaining in the player result value meter to contribute as the player input for the next turn of the game. If there is no value remaining in the player result value meter, at step 528, the processing module deducts the player input from the autonomous value meter. Otherwise, if there is value remaining in the player result value meter at step 526, at step 530, the processing module determines whether the remaining value is sufficient for the player input for the next turn of the game. If the remaining value is sufficient, the process proceeds to step 518.

If the remaining value in the player result value meter is determined to be not sufficient at step 530, at step 532, the processing module deducts all value from the player result value meter and also deducts the outstanding input amount from the autonomous value meter before proceeding to the game play at step 520.

In the above gaming process, the processing module instructs the accumulation of the win value based on an accumulation condition which is to accumulate the win value into the autonomous value meter.

With reference to FIG. 5C, at step 534, the processing module deducts a player input from the player result value meter to play a turn of the game. At step 536, the processing module instructs a random number generator for output of a game output result. At step 538, the processing module determines whether there is a win from the game output result. If there is no win, the process proceeds to step 542. Otherwise, if there is a win at step 538, at step 540, the processing module awards a win value associated with the game output result and the processing module accumulates the win value into the autonomous value meter, the player result value meter, or both, based on one or more accumulation conditions.

At step 542, for a next turn of the game, the processing module determines whether there is any value remaining in the player result value meter to contribute as the player input for the next turn of the game. If there is no value remaining in the player result value meter, at step 544, the processing module deducts the player input from the autonomous value meter. Otherwise, if there is value remaining in the player result value meter at step 542, at step 546, the processing module determines whether the remaining value is sufficient for the player input for the next turn of the game. If the remaining value is sufficient, the process proceeds to step 534.

If the remaining value in the player result value meter is determined to be not sufficient at step 546, at step 548, the processing module deducts all value from the player result value meter and also deducts the outstanding input amount from the autonomous value meter before proceeding to the game play at step 536.

In the above gaming process, the processing module instructs the accumulation of the win value based on one or more accumulation conditions. Such accumulation conditions may include, but are not limited to, comparison of the win value against one or more value thresholds, or comparison of the game output result against one or more accumulation rules pertaining to the game output result, etc.

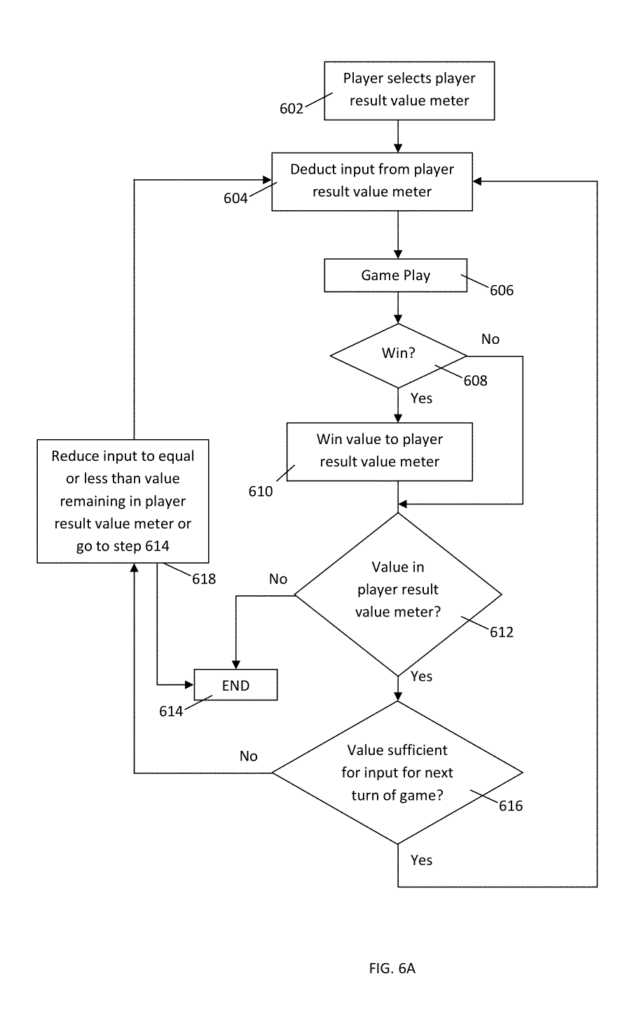

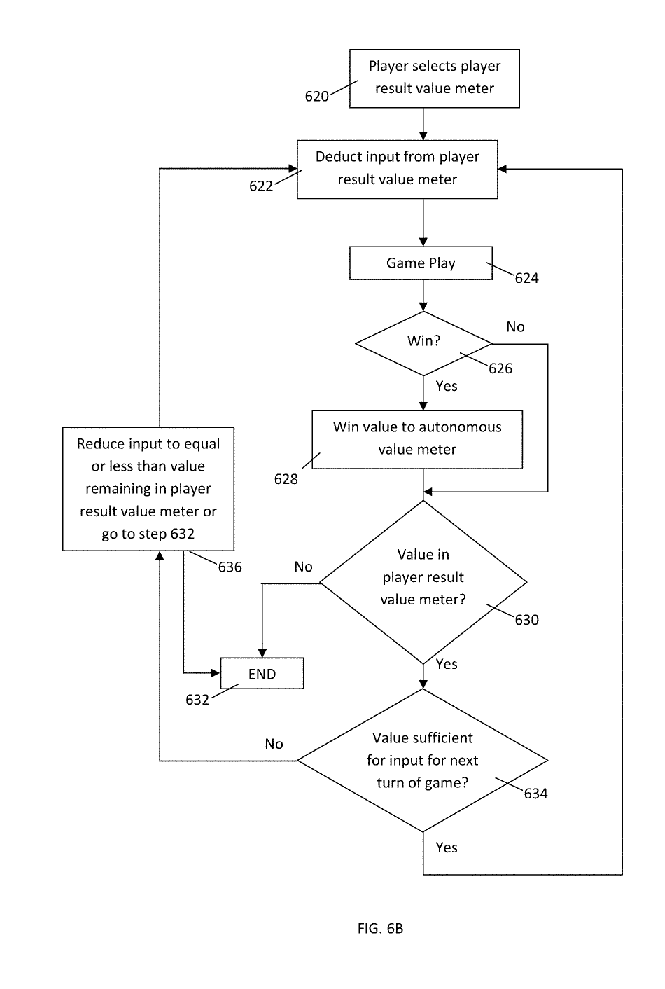

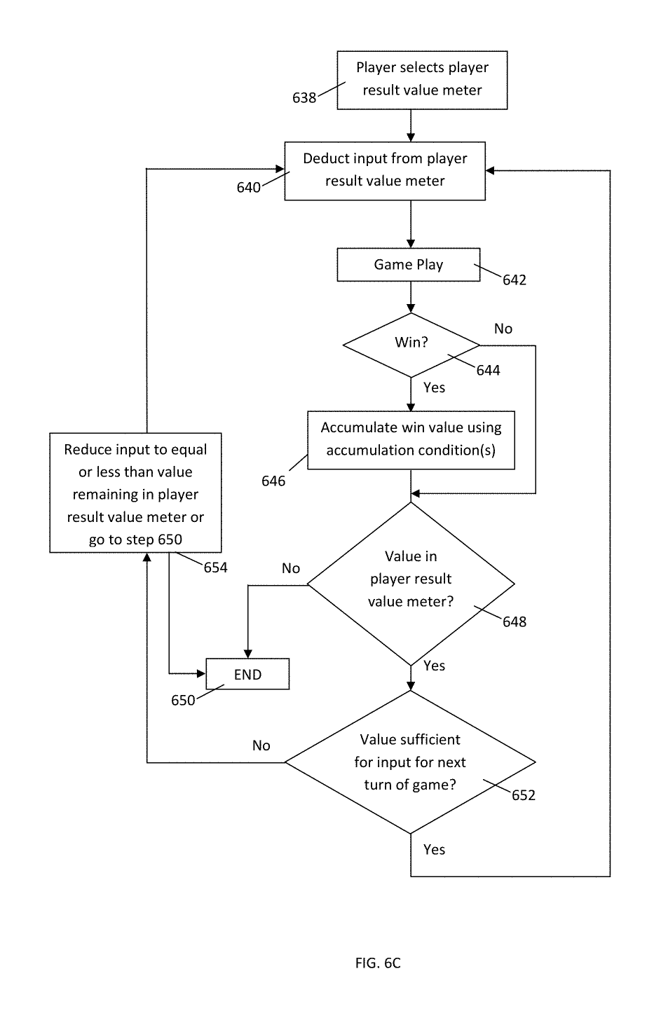

FIGS. 6A to 6C are schematic flowcharts for illustrating different gaming processes in different example embodiments where a player is allowed to select a player result value meter to play a turn of a game. The gaming processes are of a gaming apparatus that is substantially identical to the gaming apparatus 100, 200 as described in FIGS. 1A, 1B and 2. In these example embodiments, upon the player selecting the player result value meter, it may be termed that the player is selecting to play a Non-Free-Play Mode of the game.

In these example embodiments, a processing module of the gaming apparatus allows a player to select a player result value meter to deduct a player input to begin the gaming processes for playing a turn of a game. For the next turn of the game, the processing module determines whether there is value remaining in the selected player result value meter to contribute as the player input for the next turn of the game. The processing module is configured such that if an accumulated value within the selected player result value meter is not sufficient to provide the next player input for the next turn of the game, the processing module either reduces the next player input to play the next turn of the game such that the next player input can be deducted from the remaining value of the selected player result value meter or to end play of the game.

With reference to FIG. 6A, at step 602, the player selects the player result value meter for deduction of a player input.

At step 604, the processing module deducts the player input from the player result value meter to play a turn of the game. At step 606, the processing module instructs a random number generator for output of a game output result. At step 608, the processing module determines whether there is a win from the game output result. If there is no win, the process proceeds to step 612. Otherwise, if there is a win at step 608, at step 610, the processing module awards a win value associated with the game output result and the processing module accumulates the win value into the player result value meter.

At step 612, for a next turn of the game, the processing module determines whether there is any value remaining in the player result value meter to contribute as the player input for the next turn of the game. If there is no value remaining in the player result value meter, at step 614, the processing module ends or terminates play of the game.

Otherwise, if there is value remaining in the player result value meter at step 612, at step 616, the processing module determines whether the remaining value is sufficient for the player input for the next turn of the game. If the remaining value is sufficient, the process proceeds to step 604.

If the remaining value in the player result value meter is determined to be not sufficient at step 616, at step 618, the processing module reduces a value of the next player input for the next turn of the game to less than or equal to the accumulated value within the player result value meter and proceeds to step 604 such that the next player input for the next turn of the game is deducted from the accumulated value within the player result value meter. At step 618, if the processing module is not able to reduce the value of the next player input for the next turn, for example due to a minimum input amount being reached, the processing module ends or terminates play of the game at step 614.

In other example embodiments, at step 618, instead of the processing module attempting to reduce a value of the next player input for the next turn of the game to less than or equal to the accumulated value within the player result value meter, the processing module is configured to proceed to end or terminate play of the game at step 614.

In the above gaming process, the processing module instructs the accumulation of the win value based on an accumulation condition which is to accumulate the win value into the player result value meter. The processing module also allows the player to select a value meter to deduct a player input to begin the gaming processes for playing a turn of a game.

With reference to FIG. 6B, at step 620, the player selects the player result value meter for deduction of a player input.

At step 622, the processing module deducts the player input from the player result value meter to play a turn of the game. At step 624, the processing module instructs a random number generator for output of a game output result. At step 626, the processing module determines whether there is a win from the game output result. If there is no win, the process proceeds to step 630. Otherwise, if there is a win at step 626, at step 628, the processing module awards a win value associated with the game output result and the processing module accumulates the win value into the autonomous value meter.

At step 630, for a next turn of the game, the processing module determines whether there is any value remaining in the player result value meter to contribute as the player input for the next turn of the game. If there is no value remaining in the player result value meter, at step 632, the processing module ends or terminates play of the game.

Otherwise, if there is value remaining in the player result value meter at step 630, at step 634, the processing module determines whether the remaining value is sufficient for the player input for the next turn of the game. If the remaining value is sufficient, the process proceeds to step 622.

If the remaining value in the player result value meter is determined to be not sufficient at step 634, at step 636, the processing module reduces a value of the next player input for the next turn of the game to less than or equal to the accumulated value within the player result value meter and proceeds to step 622 such that the next player input for the next turn of the game is deducted from the accumulated value within the player result value meter. At step 636, if the processing module is not able to reduce the value of the next player input for the next turn, for example due to a minimum input amount being reached, the processing module ends or terminates play of the game at step 632.

In other example embodiments, at step 636, instead of the processing module attempting to reduce a value of the next player input for the next turn of the game to less than or equal to the accumulated value within the player result value meter, the processing module is configured to proceed to end or terminate play of the game at step 632.

In the above gaming process, the processing module instructs the accumulation of the win value based on an accumulation condition which is to accumulate the win value into the autonomous value meter. The processing module also allows the player to select a value meter to deduct a player input to begin the gaming processes for playing a turn of a game.

With reference to FIG. 6C, at step 638, the player selects the player result value meter for deduction of a player input.

At step 640, the processing module deducts the player input from the player result value meter to play a turn of the game. At step 642, the processing module instructs a random number generator for output of a game output result. At step 644, the processing module determines whether there is a win from the game output result. If there is no win, the process proceeds to step 648. Otherwise, if there is a win at step 644, at step 646, the processing module awards a win value associated with the game output result and the processing module accumulates the win value into the autonomous value meter, the player result value meter, or both, based on one or more accumulation conditions.

At step 648, for a next turn of the game, the processing module determines whether there is any value remaining in the player result value meter to contribute as the player input for the next turn of the game. If there is no value remaining in the player result value meter, at step 650, the processing module ends or terminates play of the game.

Otherwise, if there is value remaining in the player result value meter at step 648, at step 652, the processing module determines whether the remaining value is sufficient for the player input for the next turn of the game. If the remaining value is sufficient, the process proceeds to step 640.

If the remaining value in the player result value meter is determined to be not sufficient at step 652, at step 654, the processing module reduces a value of the next player input for the next turn of the game to less than or equal to the accumulated value within the player result value meter and proceeds to step 640 such that the next player input for the next turn of the game is deducted from the accumulated value within the player result value meter. At step 654, if the processing module is not able to reduce the value of the next player input for the next turn, for example due to a minimum input amount being reached, the processing module ends or terminates play of the game at step 650.

In other example embodiments, at step 654, instead of the processing module attempting to reduce a value of the next player input for the next turn of the game to less than or equal to the accumulated value within the player result value meter, the processing module is configured to proceed to end or terminate play of the game at step 650.

In the above gaming process, the processing module instructs the accumulation of the win value based on one or more accumulation conditions. Such accumulation conditions may include, but are not limited to, comparison of the win value against one or more value thresholds, or comparison of the game output result against one or more accumulation rules pertaining to the game output result, etc. The processing module also allows the player to select a value meter to deduct a player input to begin the gaming processes for playing a turn of a game.

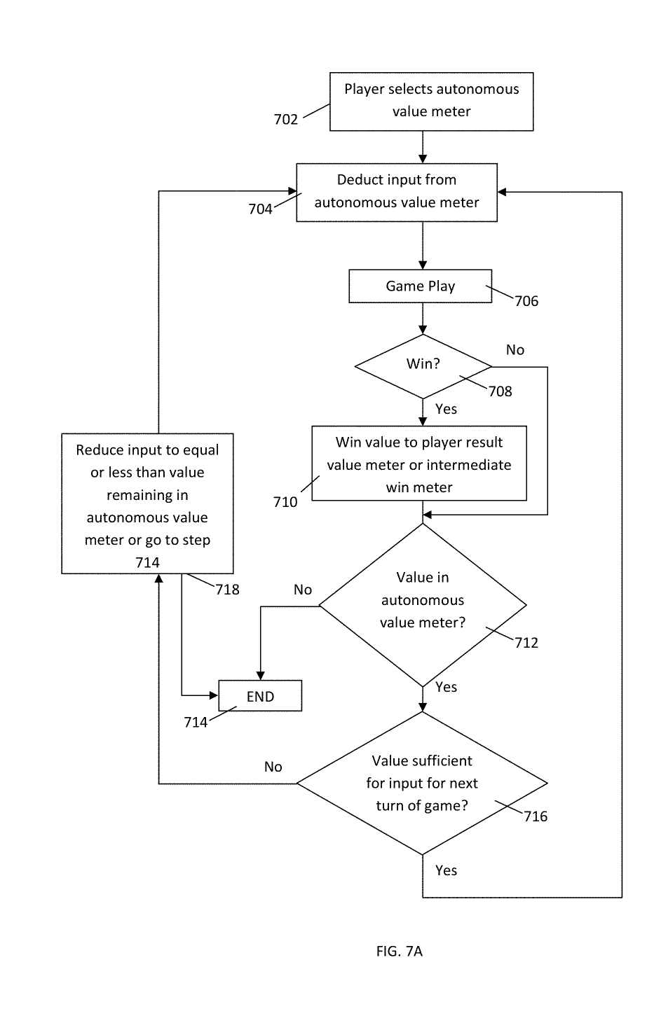

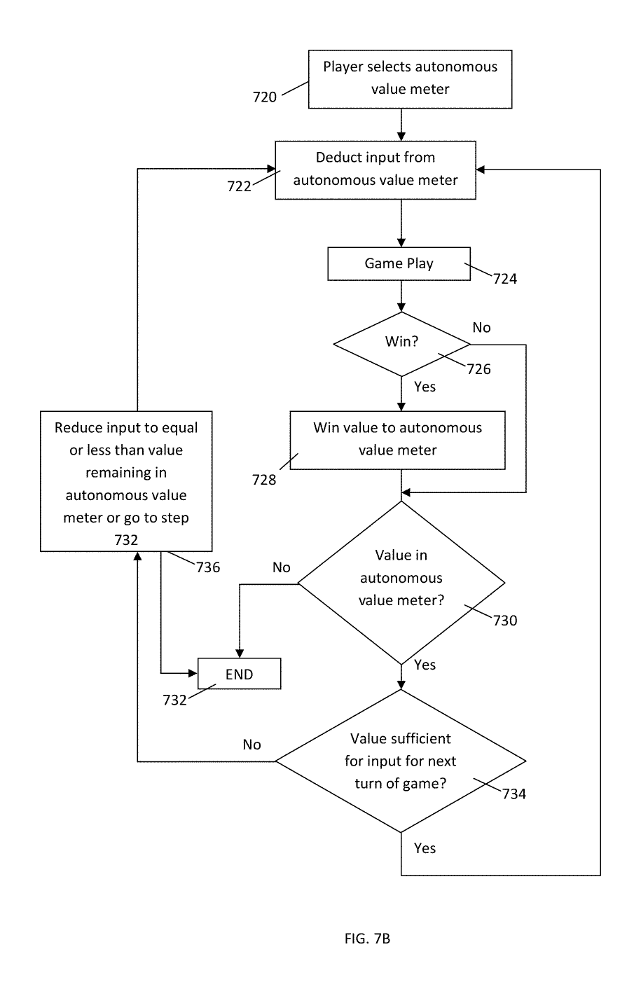

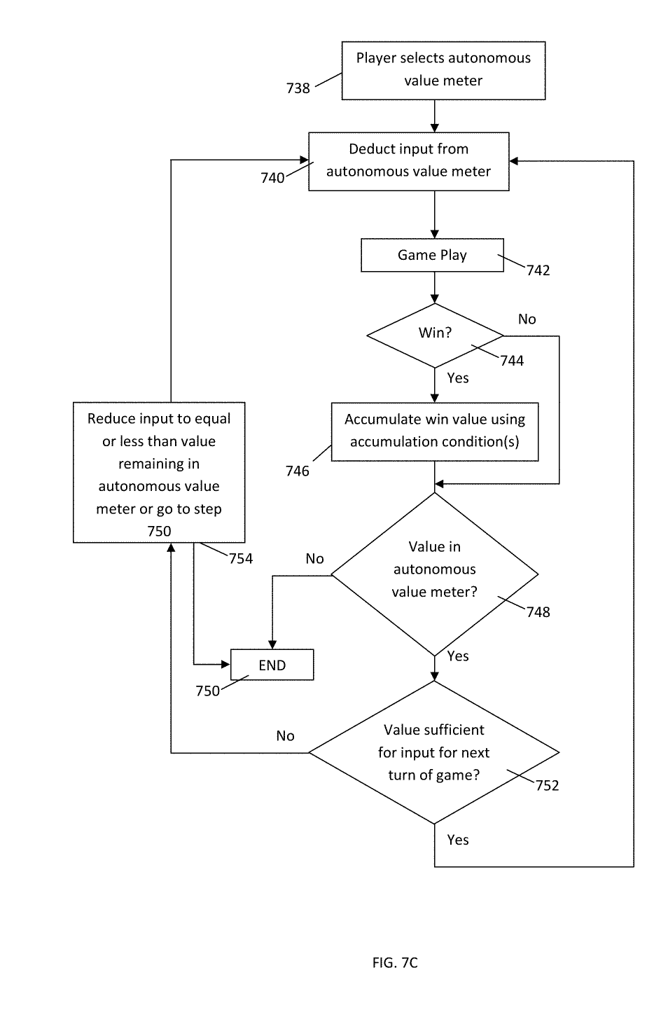

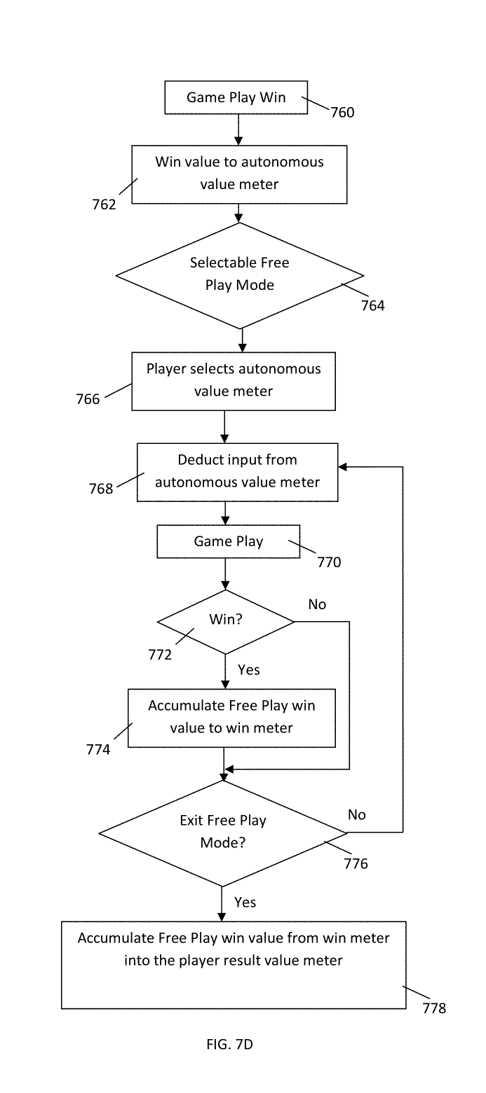

FIGS. 7A to 7C are schematic flowcharts for illustrating different gaming processes in different example embodiments where a player is allowed to select an autonomous value meter to play a turn of a game. The gaming processes are of a gaming apparatus that is substantially identical to the gaming apparatus 100, 200 as described in FIGS. 1A, 1B and 2. In these example embodiments, upon the player selecting the autonomous value meter, it may be termed that the player is selecting to play a Free-Play Mode of the game. In such example embodiments, the value accumulated in the autonomous value meter may be termed as Free Play Points and the autonomous value meter may be termed a Free Play Meter.

In these example embodiments, a processing module of the gaming apparatus allows a player to select an autonomous value meter to deduct a player input to begin the gaming processes for playing a turn of a game. For the next turn of the game, the processing module determines whether there is value remaining in the selected autonomous value meter to contribute as the player input for the next turn of the game. The processing module is configured such that if an accumulated value within the selected autonomous value meter is not sufficient to provide the next player input for the next turn of the game, the processing module either reduces the next player input to play the next turn of the game such that the next player input can be deducted from the remaining value of the selected autonomous value meter or to end play of the game.

With reference to FIG. 7A, at step 702, the player selects the autonomous value meter for deduction of a player input.

At step 704, the processing module deducts the player input from the autonomous value meter to play a turn of the game. At step 706, the processing module instructs a random number generator for output of a game output result. At step 708, the processing module determines whether there is a win from the game output result. If there is no win, the process proceeds to step 712. Otherwise, if there is a win at step 708, at step 710, the processing module awards a win value associated with the game output result and the processing module accumulates the win value into an intermediate win meter or the player result value meter.

At step 712, for a next turn of the game, the processing module determines whether there is any value remaining in the autonomous value meter to contribute as the player input for the next turn of the game. If there is no value remaining in the autonomous value meter, at step 714, the processing module ends or terminates play of the game.

Otherwise, if there is value remaining in the autonomous value meter at step 712, at step 716, the processing module determines whether the remaining value is sufficient for the player input for the next turn of the game. If the remaining value is sufficient, the process proceeds to step 704.

If the remaining value in the autonomous value meter is determined to be not sufficient at step 716, at step 718, the processing module reduces a value of the next player input for the next turn of the game to less than or equal to the accumulated value within the autonomous value meter and proceeds to step 704 such that the next player input for the next turn of the game is deducted from the accumulated value within the autonomous value meter. At step 718, if the processing module is not able to reduce the value of the next player input for the next turn, for example due to a minimum input amount being reached, the processing module ends or terminates play of the game at step 714.

In other example embodiments, at step 718, instead of the processing module attempting to reduce a value of the next player input for the next turn of the game to less than or equal to the accumulated value within the autonomous value meter, the processing module is configured to proceed to end or terminate play of the game at step 714.

At step 714, if the processing module accumulated the win value at step 710 into an intermediate win meter, the accumulated value in the win meter is transferred to the player result value meter.

In the above gaming process, the processing module instructs the accumulation of the win value based on an accumulation condition which is to accumulate the win value into the player result value meter. The processing module also allows the player to select a value meter to deduct a player input to begin the gaming processes for playing a turn of a game.

With reference to FIG. 7B, at step 720, the player selects the autonomous value meter for deduction of a player input.

At step 722, the processing module deducts the player input from the autonomous value meter to play a turn of the game. At step 724, the processing module instructs a random number generator for output of a game output result. At step 726, the processing module determines whether there is a win from the game output result. If there is no win, the process proceeds to step 730. Otherwise, if there is a win at step 726, at step 728, the processing module awards a win value associated with the game output result and the processing module accumulates the win value into the autonomous value meter.

At step 730, for a next turn of the game, the processing module determines whether there is any value remaining in the autonomous value meter to contribute as the player input for the next turn of the game. If there is no value remaining in the autonomous value meter, at step 732, the processing module ends or terminates play of the game.

Otherwise, if there is value remaining in the autonomous value meter at step 730, at step 734, the processing module determines whether the remaining value is sufficient for the player input for the next turn of the game. If the remaining value is sufficient, the process proceeds to step 722.

If the remaining value in the autonomous value meter is determined to be not sufficient at step 734, at step 736, the processing module reduces a value of the next player input for the next turn of the game to less than or equal to the accumulated value within the autonomous value meter and proceeds to step 722 such that the next player input for the next turn of the game is deducted from the accumulated value within the autonomous value meter. At step 736, if the processing module is not able to reduce the value of the next player input for the next turn, for example due to a minimum input amount being reached, the processing module ends or terminates play of the game at step 732.

In other example embodiments, at step 736, instead of the processing module attempting to reduce a value of the next player input for the next turn of the game to less than or equal to the accumulated value within the autonomous value meter, the processing module is configured to proceed to end or terminate play of the game at step 732.

In the above gaming process, the processing module instructs the accumulation of the win value based on an accumulation condition which is to accumulate the win value into the autonomous value meter. The processing module also allows the player to select a value meter to deduct a player input to begin the gaming processes for playing a turn of a game.

With reference to FIG. 7C, at step 738, the player selects the autonomous value meter for deduction of a player input.

At step 740, the processing module deducts the player input from the autonomous value meter to play a turn of the game. At step 742, the processing module instructs a random number generator for output of a game output result. At step 744, the processing module determines whether there is a win from the game output result. If there is no win, the process proceeds to step 748. Otherwise, if there is a win at step 744, at step 746, the processing module awards a win value associated with the game output result and the processing module accumulates the win value into the autonomous value meter, the player result value meter, or both, based on one or more accumulation conditions. In some example embodiments, the win value to be accumulated into the player result value meter is accumulated intermediately in a win meter.

At step 748, for a next turn of the game, the processing module determines whether there is any value remaining in the autonomous value meter to contribute as the player input for the next turn of the game. If there is no value remaining in the autonomous value meter, at step 750, the processing module ends or terminates play of the game.

Otherwise, if there is value remaining in the autonomous value meter at step 748, at step 752, the processing module determines whether the remaining value is sufficient for the player input for the next turn of the game. If the remaining value is sufficient, the process proceeds to step 740.

If the remaining value in the autonomous value meter is determined to be not sufficient at step 752, at step 754, the processing module reduces a value of the next player input for the next turn of the game to less than or equal to the accumulated value within the autonomous value meter and proceeds to step 740 such that the next player input for the next turn of the game is deducted from the accumulated value within the autonomous value meter. At step 754, if the processing module is not able to reduce the value of the next player input for the next turn, for example due to a minimum input amount being reached, the processing module ends or terminates play of the game at step 750.

In other example embodiments, at step 754, instead of the processing module attempting to reduce a value of the next player input for the next turn of the game to less than or equal to the accumulated value within the autonomous value meter, the processing module is configured to proceed to end or terminate play of the game at step 750.

At step 750, if the processing module accumulated the win value at step 746 into an intermediate win meter, the accumulated value in the win meter is transferred to the player result value meter.

In the above gaming process, the processing module instructs the accumulation of the win value based on one or more accumulation conditions. Such accumulation conditions may include, but are not limited to, comparison of the win value against one or more value thresholds, or comparison of the game output result against one or more accumulation rules pertaining to the game output result, etc. The processing module also allows the player to select a value meter to deduct a player input to begin the gaming processes for playing a turn of a game.

FIG. 7D is a schematic flowchart for illustrating a gaming process in an example embodiment where a player is allowed to select an autonomous value meter to enter a Free Play mode. The example embodiment may be implemented on a gaming apparatus with a display similar to the screenshot 300 of FIG. 3.

In the example embodiment, at step 760, when there is a win related to an output of a game output result, at step 762, the processing module of the gaming apparatus reflects the win value of step 760 as a Free Play value in the autonomous value meter (also termed as Free Play meter).

At step 764, the player is allowed to select whether to enter a Free Play mode on the gaming apparatus. For example, the player may use a touch screen to select the Free Play meter at step 766 to enter the Free Play mode. In the Free Play mode, the player input for the next turn of the game is deducted from the Free Play value of the Free Play meter.

At step 768, the processing module deducts the player input from the Free Play meter. At step 770, the processing module instructs a random number generator for output of a game output result. At step 772, the processing module determines whether there is a win from the game output result. If there is a win at step 772, at step 774, the processing module awards a Free Play win value associated with the game output result and the processing module accumulates the win value into an intermediate win meter. The win meter may be similar to the main game output result value meter 303 of FIG. 3.

If there is no win determined at step 772, the processing module proceeds to step 776. At step 776, the processing module determines whether the player has selected to exit the Free Play mode. For example, the player may use a touch screen to de-select the Free Play meter at step 776 to exit the Free Play mode. If it is determined that the player has not selected to exit the Free Play mode, the processing module proceeds to step 768.

If it is determined that the player has selected to exit the Free Play mode, at step 778, the processing module transfers the total accumulated Free Play win value in the win meter to the player result value meter.

It will be appreciated that the example illustrated with FIG. 7D exemplarily implements a selection to enter and to exit a Free Play mode. It will be appreciated that the example may be modified such that the accumulation at step 774 may be into an autonomous value meter or into both the win meter and the autonomous value meter.

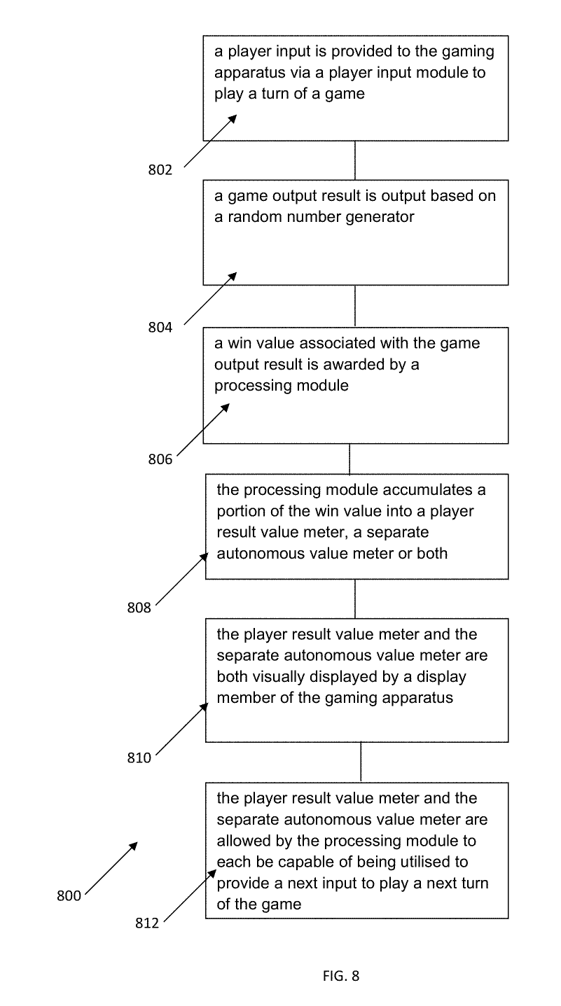

FIG. 8 is a schematic flowchart 800 for illustrating a process of accumulation of a portion of a win value between different value meters and changing the state of a gaming apparatus in an example embodiment. In other example embodiments, the process may be stored as instructions on a non-transitory storage medium.

At step 802, a player input is provided to the gaming apparatus via a player input module to play a turn of a game. At step 804, a game output result is output based on a random number generator. At step 806, a win value associated with the game output result is awarded by a processing module. At step 808, the processing module accumulates a portion of the win value into a player result value meter, a separate autonomous value meter or both. At step 810, the player result value meter and the separate autonomous value meter are both visually displayed by a display member of the gaming apparatus. At step 812, the player result value meter and the separate autonomous value meter are allowed by the processing module to each be capable of being utilised to provide a next input to play a next turn of the game.

The accumulating of step 808 may be based on one or more accumulation conditions. The method may include a further step of the processing module returning only return a final accumulated value of the player result value meter to a player account upon receiving an instruction that play is to be terminated at the gaming apparatus.

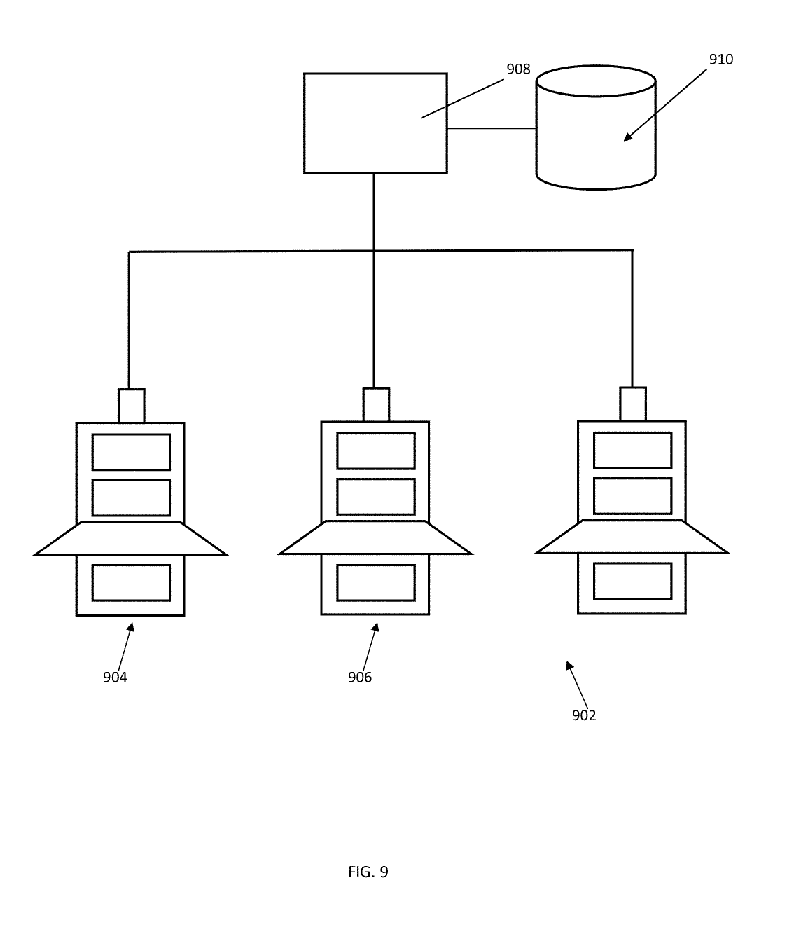

FIG. 9 is a schematic diagram illustrating a plurality of gaming apparati in a network in an example embodiment. The network 902 comprises a plurality of gaming apparati e.g. 904, 906 network-linked to a network server 908. The network links or communication links may be wired or wireless. The gaming apparati e.g. 904, 906 may each function substantially similarly to the gaming apparati as described with reference to any of FIGS. 1A, 1B and 2. The network server 908 implements server functions for the gaming apparati e.g. 904, 906. For example, the network server 908 carries out logging functions for the games performed at the gaming apparati e.g. 904, 906.

The network 902 further comprises a storage server 910 connected to the network server 908. The storage server 910 is coupled via a communication link to the network server 908.

In the example embodiment, the storage server 910 stores one or more pre-determined value thresholds and/or one or more accumulation rules and/or one or more accumulation conditions. The gaming apparati e.g. 904, 906 may retrieve the one or more pre-determined value thresholds and/or one or more accumulation rules and/or one or more accumulation conditions from the storage server 910.

In the example embodiment, the storage server 910 may additionally also function as a pool server. In such a function, the storage server 910 accumulates a pool of prizes for awarding of prizes for players at the gaming apparati e.g. 904, 906 who have a related extended event awarded. For example, a player may have a Magnification extended event that may have a pool prize awarded. The accumulation of the pool may be based on points collected from the gaming apparati e.g. 904, 906 or prizes contributed by sponsors. When a Magnification extended event is executed at the respective gaming apparatus e.g. 904, 906, a portion, or the whole, of the prizes stored in the pool server 910 is discharged to the respective gaming apparatus e.g. 904, 906. For example, 50% of the prizes may be awarded to the respective gaming apparatus.

Thus, additional entertainment may be provided to the players at the gaming apparati e.g. 904, 906 via additional prizes awarded by the pool server 910, regardless of the progress or results of the main games being played at the gaming apparati e.g. 904, 906.

In the example embodiment, the prizes may include, but are not limited to, gaming points, loyalty points, bonus points, bonus items etc. Awarding of the prizes may be via a number of methods. For example, in one method, the network server 908 transmits the ID numbers of the gaming apparati e.g. 904, 906 that have players winning their side games to an operator and the operator presents the respective prizes to the players at the respective gaming apparati e.g. 904, 906. Alternatively, bonus points may be respectively awarded electronically by the network server 908 to the players at the gaming apparati e.g. 904, 906.

In the above example embodiment, the one or more pre-determined value thresholds and/or one or more accumulation rules and/or one or more accumulation conditions are described as being stored in a storage server 910 accessible by the gaming apparati e.g. 904, 906. It will be appreciated that the described example embodiments are not limited as such and the one or more pre-determined value thresholds and/or one or more accumulation rules and/or one or more accumulation conditions may be stored stand-alone, for example in a storage device 132 of a gaming machine 100 described with reference to FIG. 1B.

In the above example embodiments, the gaming apparati are described as being in the form of arcade machines. However, it will be appreciated that the gaming apparati may include other electronic devices.

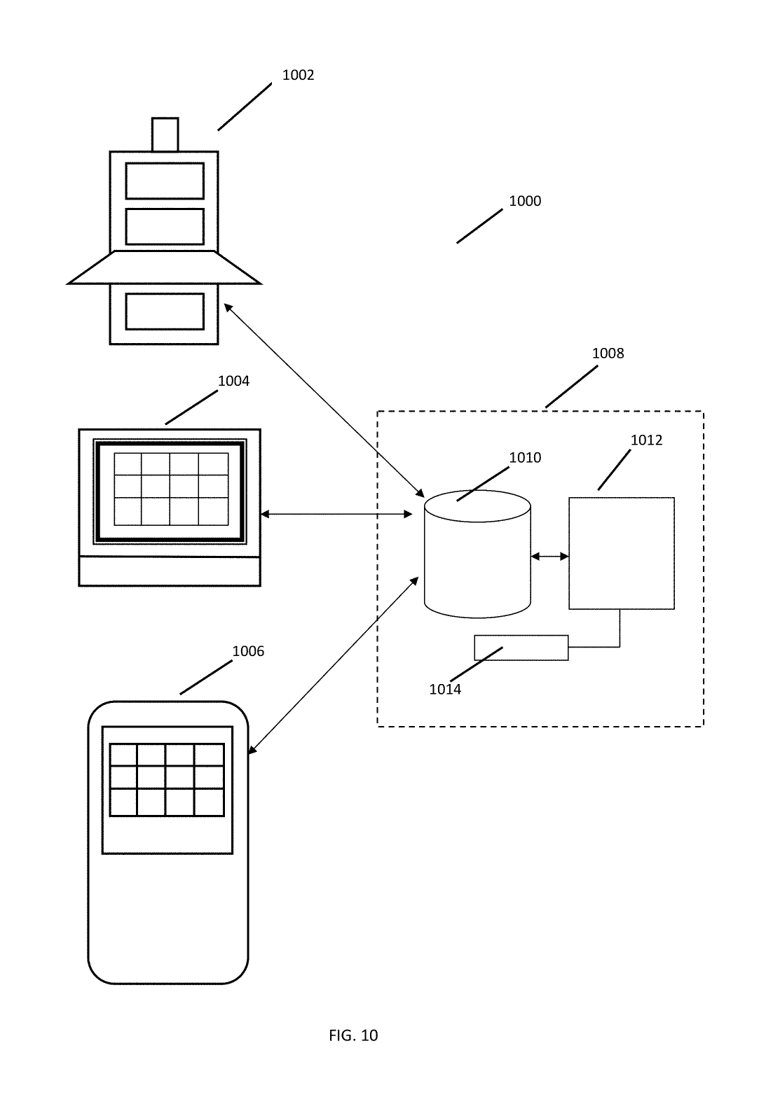

FIG. 10 shows a schematic drawing of a game system 1000 according to an example embodiment. The system 1000 comprises a plurality of gaming apparati 1002, 1004, 1006, each coupled to an game network server or unit 1008. The gaming apparati 1002, 1004, 1006 and the game unit 1008 communicate via respective network interfaces provided on the gaming apparati and the game unit. The gaming apparati 1002, 1004, 1006 may be implemented in a variety of different ways. For example, one or more of the gaming apparati 1002 are implemented as physical gaming machines such as arcade gaming machines, slot machines, electronic gaming tables or the like. One or more other gaming gaming apparati 1004 are implemented as virtual gaming machines on desktop or tablet computing devices.

One or more other gaming apparati 1006 are implemented as virtual gaming machines on portable handheld devices such as mobile phones, Personnel Digital Assistants (PDAs) or the like. The virtual gaming machines 1004, 1006 may be implemented via Wi-Fi, the Internet, interactive TV or other service networks. The coupling between the game unit 1008 and the respective gaming apparati 1002, 1004, 1006 may be implemented in a variety of different ways, including via W-Fi, the Internet, or via other wired or wireless networks.

The game unit 1008 comprises a database 1010 for storing data for conducting one or more main games and other information such as information identifying the respective gaming apparati 1002, 1004, 1006. The database 1010 also stores one or more predetermined value thresholds and/or one or more accumulation rules and/or one or more accumulation conditions. The gaming apparati e.g. 1002, 1004, 1006 may retrieve the one or more pre-determined value thresholds and/or one or more accumulation rules and/or one or more accumulation conditions from the database 1010.

Further, the game unit 1008 comprises a processor unit/module 1012 coupled to the database 1010. The processor module 1012 is capable of awarding prizes to players on the respective gaming apparati 1002, 1004, 1006, e.g. based on the information stored in the database 1010. The processor module 1012 is coupled to a pool database 1014 comprising a prize pool.

The processing module 1012 is also configured to award a win value associated with the game output result at each gaming apparati 1002, 1004, 1006 and is further configured to accumulate a portion of the win value into a player result value meter, a separate autonomous value meter or both at each gaming apparati 1002, 1004, 1006. The processing module 1012 is configured to allow the player result value meter and the separate autonomous value meter to each be capable of being utilised to provide a next input to play a next turn of the game.

During execution of the one or more main games, the processor module 1012 is capable of instructing play of the main games at the plurality of gaming apparati 1002, 1004, 1006. In addition, the processor module 1012 is capable of awarding a portion, or a whole, of the prize pool from the pool database 1014 to players at respective gaming apparati 1002, 1004, 1006.

The processor module 1012 awards the pool prizes based on results of e.g. extended game events and independent of the main games implemented on the respective gaming apparati 1002, 1004, 1006. It will be appreciated that the game system 1000 thus provides a distributed gaming environment with a centralized game database for awarding prizes to players on the respective gaming apparati 1002, 1004, 1006.

In the above example embodiment, the one or more pre-determined value thresholds and/or one or more accumulation rules and/or one or more accumulation conditions are described as being stored in a database 1010 of a game unit 1008 and is accessible by the gaming apparati e.g. 1002, 1004, 1006. It will be appreciated that the described example embodiments are not limited as such and the one or more pre-determined value thresholds and/or one or more accumulation rules and/or one or more accumulation conditions may be stored stand-alone within each gaming apparatus, for example in a storage device 132 of a gaming machine 100 described with reference to FIG. 1B.

In the described example embodiments, a separate autonomous value meter is provided automatically and separate from a player result value meter. The autonomous value meter, termed as a free play meter, is deductible for player inputs for game plays. As the autonomous value meter is not returned to a player account, the accumulated value in the autonomous value meter may allow a player to prolong playing games at a gaming apparatus/machine. The player may therefore enjoy entertainment and features such as free games, multipliers, bonuses or even jackpot wins, apart from normal game play. That is, in certain scenarios, having the autonomous value meter which may prolong playing time, the player has increased chances of activating entertainment and features mentioned above, as compared to conventional use of only a player result value meter. In addition, the inventors have recognized that implementation of the example embodiments may avoid affecting original game play perception based on an intended design.

The inventors have also recognized that it is possible in the described example embodiments to award a pre-determined multiplier to the points for value accumulation into the autonomous value meter, as compared to value accumulation into the player result value meter. For example, if a win value of 1 point is to be allocated to the autonomous value meter, a pre-determined multiplier of 5 may be implemented such that 5 points are accumulated into the autonomous value meter. On the other hand, if the 1 point is allocated to the player result value meter, the actual 1 point is accumulated into the player result value meter.

Therefore, there may be more “free points” made available for a player to have prolonged play at the gaming apparatus/machine. In this way as well, the real Return To Player (RTP) is still maintained and not changed, given that the accumulation of value into the player result value meter is not changed and only the final accumulated value of the player result meter is returned to a player account upon play being terminated at the gaming apparatus.

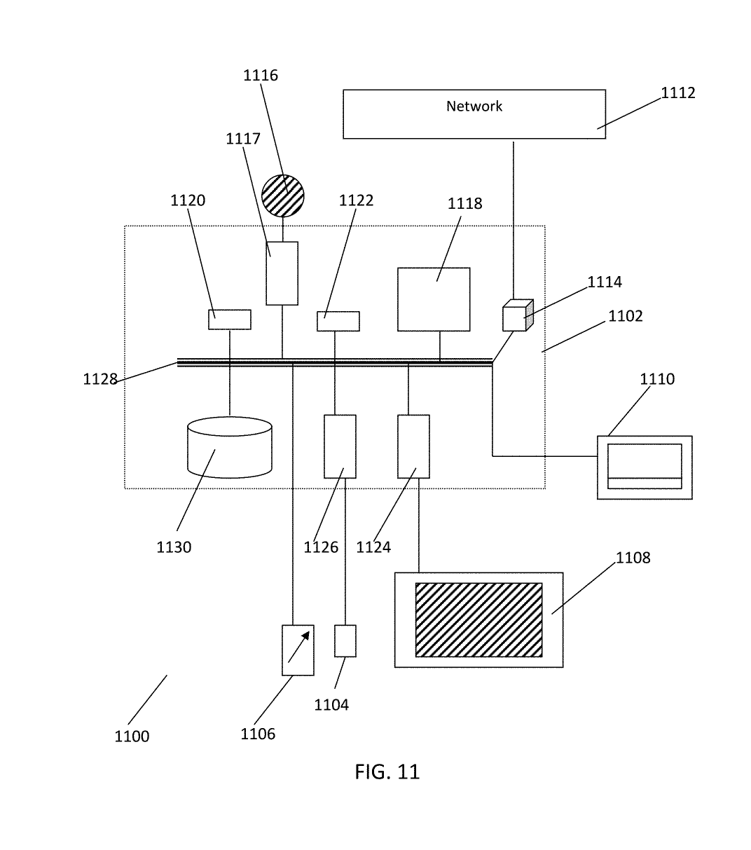

Different example embodiments can be implemented in the context of data structure, program modules, program and computer instructions executed in a computer implemented environment. A general purpose computing environment is briefly disclosed herein. One or more example embodiments may be embodied in one or more computer systems, such as is schematically illustrated in FIG. 11.

One or more example embodiments may be implemented as software, such as a computer program being executed within a computer system 1100, and instructing the computer system 1100 to conduct a method of an example embodiment.

The computer system 1100 comprises a computer unit 1102, input modules such as a keyboard 1104 and a pointing device 1106 and a plurality of output devices such as a display 1108, and printer 1110. A user can interact with the computer unit 1102 using the above devices. The pointing device can be implemented with a mouse, track ball, pen device or any similar device. One or more other input devices (not shown) such as a joystick, game pad, satellite dish, scanner, touch sensitive screen or the like can also be connected to the computer unit 1102. Such input devices may function as player input devices/modules arranged to accept a player input. The display 1108 may include a cathode ray tube (CRT), liquid crystal display (LCD), field emission display (FED), plasma display or any other device that produces an image that is viewable by the user.

The computer unit 1102 can be connected to a computer network 1112 via a suitable transceiver device 1114, to enable access to e.g. the Internet or other network systems such as Local Area Network (LAN) or Wide Area Network (WAN) or a personal network. The network 1112 can comprise a server, a router, a network personal computer, a peer device or other common network node, a wireless telephone or wireless personal digital assistant. Networking environments may be found in offices, enterprise-wide computer networks and home computer systems etc. The transceiver device 1114 can be a modem/router unit located within or external to the computer unit 1102, and may be any type of modem/router such as a cable modem or a satellite modem.

It will be appreciated that network connections shown are exemplary and other ways of establishing a communications link between computers can be used. The existence of any of various protocols, such as TCP/IP, Frame Relay, Ethernet, FTP, HTTP and the like, is presumed, and the computer unit 1102 can be operated in a client-server configuration to permit a user to retrieve web pages from a web-based server. Furthermore, any of various web browsers can be used to display and manipulate data on web pages.

The computer unit 1102 in the example comprises a processor 1118, a Random Access Memory (RAM) 1120 and a Read Only Memory (ROM) 1122. The ROM 1122 can be a system memory storing basic input/output system (BIOS) information. The RAM 1120 can store one or more program modules such as operating systems, application programs and program data.

The processor 1118 may function as a processing module to accumulate a portion of a win value associated with a game output result into a player result value meter, a separate autonomous value meter or both. The processor 1118 may also allow the player result value meter and the separate autonomous value meter to each be capable of being utilised to provide a next input to play a next turn of a game. The processor 1118 may also perform as, or instruct functions, of a random number generator to output a game output result. The RAM 1120 may store one or more pre-determined value thresholds and/or one or more accumulation rules and/or one or more accumulation conditions.

The computer unit 1102 further comprises a number of Input/Output (I/O) interface units, for example I/O interface unit 1124 to the display 1108, and I/O interface unit 1126 to the keyboard 1104. The components of the computer unit 1102 typically communicate and interface/couple connectedly via an interconnected system bus 1128 and in a manner known to the person skilled in the relevant art. The bus 1128 can be any of several types of bus structures including a memory bus or memory controller, a peripheral bus, and a local bus using any of a variety of bus architectures.

It will be appreciated that other devices can also be connected to the system bus 1128. For example, a universal serial bus (USB) interface can be used for coupling a video or digital camera to the system bus 1128. An IEEE 1394 interface may be used to couple additional devices to the computer unit 1102. Other manufacturer interfaces are also possible such as FireWire developed by Apple Computer and i.Link developed by Sony. Coupling of devices to the system bus 1128 can also be via a parallel port, a game port, a PCI board or any other interface used to couple an input device to a computer. It will also be appreciated that, while the components are not shown in the figure, sound/audio can be recorded and reproduced with a microphone and a speaker. A sound card may be used to couple a microphone and a speaker to the system bus 1128. It will be appreciated that several peripheral devices can be coupled to the system bus 1128 via alternative interfaces simultaneously.

An application program can be supplied to the user of the computer system 1100 being encoded/stored on a data storage medium such as a CD-ROM or flash memory carrier. The application program can be read using a corresponding data storage medium drive of a data storage device 1130. The data storage medium is not limited to being portable and can include instances of being embedded in the computer unit 1102. The data storage device 1130 can comprise a hard disk interface unit and/or a removable memory interface unit (both not shown in detail) respectively coupling a hard disk drive and/or a removable memory drive to the system bus 1128. This can enable reading/writing of data. Examples of removable memory drives include magnetic disk drives and optical disk drives. The drives and their associated computer-readable media, such as a floppy disk provide nonvolatile storage of computer readable instructions, data structures, program modules and other data for the computer unit 1102. It will be appreciated that the computer unit 1102 may include several of such drives. Furthermore, the computer unit 1102 may include drives for interfacing with other types of computer readable media.

The application program is read and controlled in its execution by the processor 1118. Intermediate storage of program data may be accomplished using RAM 1120. The method(s) of the example embodiments can be implemented as computer readable instructions, computer executable components, or software modules. One or more software modules may alternatively be used. These can include an executable program, a data link library, a configuration file, a database, a graphical image, a binary data file, a text data file, an object file, a source code file, or the like. When one or more computer processors execute one or more of the software modules, the software modules interact to cause one or more computer systems to perform according to the teachings herein.

The operation of the computer unit 1102 can be controlled by a variety of different program modules. Examples of program modules are routines, programs, objects, components, data structures, libraries, etc. that perform particular tasks or implement particular abstract data types. The example embodiments may also be practiced with other computer system configurations, including handheld devices, multiprocessor systems, microprocessor-based or programmable consumer electronics, network PCs, minicomputers, mainframe computers, personal digital assistants, mobile telephones and the like. Furthermore, the example embodiments may also be practiced in distributed computing environments where tasks are performed by remote processing devices that are linked through a wireless or wired communications network. In a distributed computing environment, program modules may be located in both local and remote memory storage devices.

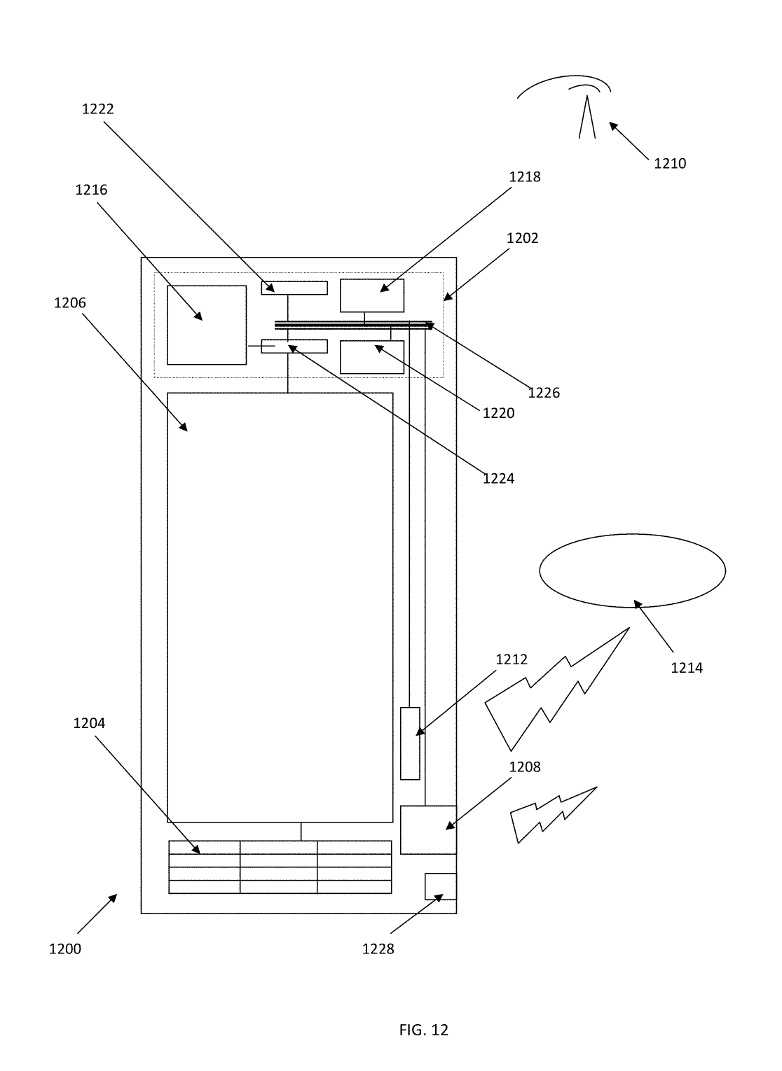

Further to the above, different example embodiments can be implemented in the context of data structure, program modules, program and computer instructions executed in a communication device. An exemplary communication device is briefly disclosed herein. One or more example embodiments may be embodied in one or more communication devices e.g. 1200, such as is schematically illustrated in FIG. 12.

One or more example embodiments may be implemented as software, such as a computer program being executed within a communication device 1200, and instructing the communication device 1200 to conduct a method of an example embodiment.

The communication device 1200 comprises a processor module 1202, an input module such as a touchscreen interface or a keypad 1204 and an output module such as a display 1206 on a touchscreen.

The processor module 1202 is coupled to a first communication unit 1208 for communication with a cellular network 1210. The first communication unit 1208 can include, but is not limited to, a subscriber identity module (SIM) card loading bay. The cellular network 1210 can, for example, be a 3G or 4G network.

The processor module 1202 is further coupled to a second communication unit 1212 for connection to a network 1214. For example, the second communication unit 1212 can enable access to e.g. the Internet or other network systems such as Local Area Network (LAN) or Wide Area Network (WAN) or a personal network. The network 1214 can comprise a server, a router, a network personal computer, a peer device or other common network node, a wireless telephone or wireless personal digital assistant. Networking environments may be found in offices, enterprise-wide computer networks and home computer systems etc. The second communication unit 1212 can include, but is not limited to, a wireless network card or an ethernet network cable port. The second communication unit 1212 can also be a modem/router unit and may be any type of modem/router such as a cable-type modem or a satellite-type modem.

It will be appreciated that network connections shown are exemplary and other ways of establishing a communications link between computers can be used. The existence of any of various protocols, such as TCP/IP, Frame Relay, Ethernet, FTP, HTTP and the like, is presumed, and the communication device 1200 can be operated in a client-server configuration to permit a user to retrieve web pages from a web-based server. Furthermore, any of various web browsers can be used to display and manipulate data on web pages.

The processor module 1202 in the example includes a processor 1216, a Random Access Memory (RAM) 1218 and a Read Only Memory (ROM) 1220. The ROM 1220 can be a system memory storing basic input/output system (BIOS) information. The RAM 1218 can store one or more program modules such as operating systems, application programs and program data.

The processor 1216 may function as a processing module to accumulate a portion of a win value associated with a game output result into a player result value meter, a separate autonomous value meter or both. The processor 1216 may also allow the player result value meter and the separate autonomous value meter to each be capable of being utilised to provide a next input to play a next turn of a game. The processor 1216 may also perform as, or instruct functions of, a random number generator to output a game output result. The RAM 1218 may store one or more pre-determined value thresholds and/or one or more accumulation rules and/or one or more accumulation conditions.

The processor module 1202 also includes a number of Input/Output (I/O) interfaces, for example I/O interface 1222 to the display 1206, and I/O interface 1224 to the keypad 1204.

The components of the processor module 1202 typically communicate and interface/couple connectedly via an interconnected bus 1226 and in a manner known to the person skilled in the relevant art. The bus 1226 can be any of several types of bus structures including a memory bus or memory controller, a peripheral bus, and a local bus using any of a variety of bus architectures.

It will be appreciated that other devices can also be connected to the system bus 1226. For example, a universal serial bus (USB) interface can be used for coupling an accessory of the communication device, such as a card reader, to the system bus 1226.

The application program is typically supplied to the user of the communication device 1200 encoded on a data storage medium such as a flash memory module or memory card/stick and read utilising a corresponding memory reader-writer of a data storage device 1228. The data storage medium is not limited to being portable and can include instances of being embedded in the communication device 1200.

The application program is read and controlled in its execution by the processor 1216. Intermediate storage of program data may be accomplished using RAM 1218. The method(s) of the example embodiments can be implemented as computer readable instructions, computer executable components, or software modules. One or more software modules may alternatively be used. These can include an executable program, a data link library, a configuration file, a database, a graphical image, a binary data file, a text data file, an object file, a source code file, or the like. When one or more processor modules execute one or more of the software modules, the software modules interact to cause one or more processor modules to perform according to the teachings herein.

The operation of the communication device 1200 can be controlled by a variety of different program modules. Examples of program modules are routines, programs, objects, components, data structures, libraries, etc. that perform particular tasks or implement particular abstract data types.

The example embodiments may also be practiced with other computer system configurations, including handheld devices, multiprocessor systems/servers, microprocessor-based or programmable consumer electronics, network PCs, minicomputers, mainframe computers, personal digital assistants, mobile telephones and the like. Furthermore, the example embodiments may also be practiced in distributed computing environments where tasks are performed by remote processing devices that are linked through a wireless or wired communications network. In a distributed computing environment, program modules may be located in both local and remote memory storage devices.

The terms “coupled” or “connected” as used in this description are intended to cover both directly connected or connected through one or more intermediate means, unless otherwise stated.

The description herein may be, in certain portions, explicitly or implicitly described as algorithms and/or functional operations that operate on data within a computer memory or an electronic circuit. These algorithmic descriptions and/or functional operations are usually used by those skilled in the information/data processing arts for efficient description. An algorithm is generally relating to a self-consistent sequence of steps leading to a desired result. The algorithmic steps can include physical manipulations of physical quantities, such as electrical, magnetic or optical signals capable of being stored, transmitted, transferred, combined, compared, and otherwise manipulated.

Further, unless specifically stated otherwise, and would ordinarily be apparent from the following, a person skilled in the art will appreciate that throughout the present specification, discussions utilizing terms such as “scanning”, “calculating”, “determining”, “replacing”, “generating”, “initializing”, “outputting”, and the like, refer to action and processes of an instructing processor/computer system, or similar electronic circuit/device/component, that manipulates/processes and transforms data represented as physical quantities within the described system into other data similarly represented as physical quantities within the system or other information storage, transmission or display devices etc.

The description also discloses relevant device/apparatus for performing the steps of the described methods. Such apparatus may be specifically constructed for the purposes of the methods, or may comprise a general purpose computer/processor or other device selectively activated or reconfigured by a computer program stored in a storage member.

The algorithms and displays described herein are not inherently related to any particular computer or other apparatus. It is understood that general purpose devices/machines may be used in accordance with the teachings herein. Alternatively, the construction of a specialized device/apparatus to perform the method steps may be desired.

In addition, it is submitted that the description also implicitly covers a computer program, in that it would be clear that the steps of the methods described herein may be put into effect by computer code. It will be appreciated that a large variety of programming languages and coding can be used to implement the teachings of the description herein. Moreover, the computer program if applicable is not limited to any particular control flow and can use different control flows without departing from the scope of the invention.

Furthermore, one or more of the steps of the computer program if applicable may be performed in parallel and/or sequentially. Such a computer program if applicable may be stored on any computer readable medium. The computer readable medium may include storage devices such as magnetic or optical disks, memory chips, or other storage devices suitable for interfacing with a suitable reader/general purpose computer. In such instances, the computer readable storage medium is non-transitory. Such storage medium also covers all computer-readable media e.g. medium that stores data only for short periods of time and/or only in the presence of power, such as register memory, processor cache and Random Access Memory (RAM) and the like. The computer readable medium may even include a wired medium such as exemplified in the Internet system, or wireless medium such as exemplified in bluetooth technology. The computer program when loaded and executed on a suitable reader effectively results in an apparatus that can implement the steps of the described methods.

The example embodiments may also be implemented as hardware modules. A module is a functional hardware unit designed for use with other components or modules. For example, a module may be implemented using digital or discrete electronic components, or it can form a portion of an entire electronic circuit such as an Application Specific Integrated Circuit (ASIC). A person skilled in the art will understand that the example embodiments can also be implemented as a combination of hardware and software modules.

Additionally, when describing some embodiments, the disclosure may have disclosed a method and/or process as a particular sequence of steps. However, unless otherwise required, it will be appreciated the method or process should not be limited to the particular sequence of steps disclosed. Other sequences of steps may be possible. The particular order of the steps disclosed herein should not be construed as undue limitations. Unless otherwise required, a method and/or process disclosed herein should not be limited to the steps being carried out in the order written. The sequence of steps may be varied and still remain within the scope of the disclosure.

Further, in the description herein, the word “substantially” whenever used is understood to include, but not restricted to, “entirely” or “completely” and the like. In addition, terms such as “comprising”, “comprise”, and the like whenever used, are intended to be non-restricting descriptive language in that they broadly include elements/components recited after such terms, in addition to other components not explicitly recited. Further, terms such as “about”, “approximately” and the like whenever used, typically means a reasonable variation, for example a variation of +/−5% of the disclosed value, or a variance of 4% of the disclosed value, or a variance of 3% of the disclosed value, a variance of 2% of the disclosed value or a variance of 1% of the disclosed value.

Furthermore, in the description herein, certain values may be disclosed in a range. The values showing the end points of a range are intended to illustrate a preferred range. Whenever a range has been described, it is intended that the range covers and teaches all possible sub-ranges as well as individual numerical values within that range. That is, the end points of a range should not be interpreted as inflexible limitations. For example, a description of a range of 1% to 5% is intended to have specifically disclosed sub-ranges 1% to 2%, 1% to 3%, 1% to 4%, 2% to 3% etc., as well as individually, values within that range such as 1%, 2%, 3%, 4% and 5%. The intention of the above specific disclosure is applicable to any depth/breadth of a range.

It will be appreciated that the gaming apparatus/machine described in the example embodiments are not limited to the form as illustrated in the description. The example embodiments may also be implemented with gaming machines such as slot machines or electronic gaming machines (EGMs).

Furthermore, it will be appreciated that in the example embodiments, the accumulated value in the separate autonomous value meter, while not returnable to a player account, may be used to redeem non-credit and non-monetary prizes for a player.

In addition, in the example embodiments, the accumulated value in the player result value meter returned to the player account may be used to play future games. However, in some example embodiments, the player account may not be able to be exchanged into cash, money or credits. That is, such example embodiments may be implemented for non-gambling purposes.

It will be appreciated by a person skilled in the art that other variations and/or modifications may be made to the specific embodiments without departing from the scope of the invention as broadly described. The present embodiments are, therefore, to be considered in all respects to be illustrative and not restrictive.

1. A gaming apparatus, the gaming apparatus comprising,
a display member configured to visually display both a player result value meter and a separate autonomous value meter;
a player input module arranged to accept a player input to play a turn of a game;
a random number generator arranged for output of a game output result;
a processing module configured to award a win value associated with the game output result, the processing module further configured to accumulate a portion of the win value into the separate autonomous value meter or both the player result value meter and the separate autonomous value meter;
wherein any value accumulated in the separate autonomous value meter is not returnable to a player; and
wherein the processing module is configured to allow at least one of the player result value meter and the separate autonomous value meter to be capable of being utilised to provide a next input to play a next turn of the game.

2. The gaming apparatus as claimed in claim 1, wherein the processing module is further configured to accumulate the portion of the win value into the separate autonomous value meter or both the player result value meter and the separate autonomous value meter, based on one or more accumulation conditions.

3. The gaming apparatus as claimed in claim 2, further comprising the processing module being configured to accumulate a portion of the win value into the separate autonomous value meter or both the player result value meter and the separate autonomous value meter, based on a comparison performed by the processing module of the win value against a pre-determined value threshold.

4. The gaming apparatus as claimed in claim 2, further comprising the processing module being configured to accumulate a portion of the win value into the separate autonomous value meter or both the player result value meter and the separate autonomous value meter, based on a comparison performed by the processing module of the game output result against one or more accumulation rules pertaining to the game output result.

5. The gaming apparatus as claimed in claim 1, further comprising the processing module being configured to automatically select one of the player result value meter and the separate autonomous value meter as a selected meter to provide the next input to play the next turn of the game, and wherein if an accumulated value within the selected meter is not sufficient to provide the next input, the processing module is configured to deduct the accumulated value within the selected meter and to deduct an outstanding amount of the next input from a non-selected meter.

6. The gaming apparatus as claimed in claim 1, further comprising the player input module being configured to accept a player instruction to instruct the processing module to select one of the player result value meter and the separate autonomous value meter as a selected meter to provide the next input to play the next turn of the game, and wherein if an accumulated value within the selected meter is not sufficient to provide the next input, the processing module is configured to reduce a value of the next input to less than or equal to the accumulated value within the selected meter such that the next input is deducted from the accumulated value within the selected meter.

7. The gaming apparatus as claimed in claim 1, further comprising the player input module being configured to accept a player instruction to instruct the processing module to select one of the player result value meter and the separate autonomous value meter as a selected meter to provide the next input to play the next turn of the game, and wherein if an accumulated value within the selected meter is not sufficient to provide the next input, the processing module is configured to terminate play of the game.

8. The gaming apparatus as claimed in claim 1, further comprising the processing module being configured to only return a final accumulated value of the player result value meter to a player account upon receiving an instruction that play is to be terminated at the gaming apparatus.

9. The gaming apparatus as claimed in claim 1, further comprising the display member configured to visually display a win meter, the processing module being configured to provide a selectable play mode, wherein if the play mode is selected, the processing module is further configured to accumulate the portion of the win value into the win meter, the win meter being configured to function as an intermediate meter, and wherein the processing module is also configured to determine if a selection to exit the play mode has been made and if it is determined that an exit of the play mode has been selected, the processing module is configured to transfer a total amount accumulated in the win meter into the player result value meter.
